(19) United States
(12) Patent Application Publication
(10) Pub. No.: US 2015/0351884 A1
(43) Pub. Date: Dec. 10, 2015

(54) MOTORIZED TOOTHBRUSH

(71) Applicant: ALFRED SALAZAR, MISSION, TX (US)

(72) Inventor: ALFRED SALAZAR, MISSION, TX (US)

(21) Appl. No.: 14/298,630

(22) Filed: Jun. 6, 2014

(51) Int. Cl. A61C 17/26

(52) U.S. Cl. CPC A61C 17/26

(57) ABSTRACT

A toothbrush having an outer housing with three orifices, a neck portion, and a head portion. Three gears, each engaged with a respective landing in the head portion, include a portion that extends through a respective orifice in the housing aligned with the landings. A rotatable component engages the portion of each gear extending through an orifice. A shaft in the neck portion engages a motor or other type of actuator. In use, rotation of the shaft causes rotation of the first gear and associated rotatable component, which causes rotation of the second gear and rotateable component in an opposing direction, which in turn causes rotation of the third gear and rotatable component in the first direction.

### FIELD

Embodiments usable within the scope of the present disclosure relate, generally, to dental apparatus, and more specifically, to toothbrushes (e.g., motorized toothbrushes) having portions movable in rotational directions relative to other portions thereof.

### BACKGROUND

Existing toothbrushes include both manual and powered varieties. A manual toothbrush typically includes a rigid handle (e.g., a plastic rod) having multiple groups of bristles made from nylon or a similar synthetic fiber extending from an end. In use, these bristles, in combination with an abrasive and/or antiseptic gel or paste, are manually moved along surfaces of a user's teeth. The manual technique used when brushing teeth in this manner can greatly affect the effectiveness of the cleaning. For example, manually moving the bristles in a variety of directions (e.g., vertically, horizontally, circularly), and conspicuously brushing every surface of every tooth, including regions between teeth, can provide enhanced effectiveness versus less focused brushing techniques. Improvements to manual toothbrushes have included variations in the dimensions, shapes, and composition of bristles, and the shape and/or flexibility of the handle and brush head to facilitate access to all dental surfaces.

Because effective manual brushing techniques can be tedious and/or time-consuming to properly execute, powered/electrical toothbrushes have been developed. While colloquially dubbed “rotary” toothbrushes, the large majority of modern electrical toothbrushes do not actually include any rotating parts, but instead utilize parts that vibrate and/or oscillate back and forth in a manner that may simulate rotation. While electric toothbrushes require considerably less manual effort to use, particularly for individuals with orthodontic appliances and/or limited manual dexterity, most independent research indicates that existing electric toothbrushes perform only marginally better than a manual toothbrush, while presenting a considerably greater expense.

One example of a rotary toothbrush is described in United States Patent Application 2010/0330538, which is incorporated by reference herein in its entirety. However, a need remains for rotary toothbrushes having structural features that facilitate effective cleaning, ease of use, access to all dental surfaces, and inexpensive manufacture.

### SUMMARY

Embodiments usable within the scope of the present disclosure include toothbrushes (e.g., motorized toothbrushes) that include an outer housing having a first orifice, a second orifice, and a third orifice formed therein, as well as a neck portion having an axial bore therein, and a head portion. The head portion can include a first landing adjacent to the neck portion and aligned with the first orifice, a second landing adjacent to the first landing and aligned with the second orifice, and a third landing adjacent to the second landing and aligned with the third orifice. In an embodiment, the outer housing can include an upper body portion and a lower body portion (e.g., secured together), the upper body portion having the first, second, and third orifices formed therein, and the lower body portion having the first, second, and third landings formed therein.

A first gear can be engaged with the first landing and include a first portion extending through the first orifice. A second gear can be engaged with the second landing and the first gear and can include a second portion extending through the second orifice. A third gear can be engaged with the third landing and the second gear and can include a third portion extending through the third orifice. A first rotatable element can be engaged with the first portion of the first gear, a second rotatable element can be engaged with the second portion of the second gear, and a third rotatable element can be engaged with the third portion of the third gear. A shaft can be positioned within the axial bore and engaged with the first gear, such that rotation of the shaft about an axis of the bore imparts rotational movement to the first gear about an axis perpendicular to that of the bore, in a first direction, thereby rotating the first rotatable element. Rotation of the first gear imparts rotational movement to the second gear, and thereby the second rotatable element, in a second direction opposite the first. Rotation of the second gear imparts rotational movement to the third gear, and thereby the third rotatable element, in the first rotational direction.

In an embodiment, landings can each have a respective receptacle formed therein (e.g., centrally positioned, or positioned elsewhere). Each gear can have an insertion region (e.g., an extension protruding therefrom) that can be inserted into a corresponding receptacle (e.g., the first gear into the receptacle in the first landing, the second gear into the receptacle in the second landing, and the third gear into the receptacle in the third landing). Engagement between the gears and landings in this manner can be undertaken in a manner that permits rotation of the gears relative to the respective landings.

In an embodiment, the head portion of the housing can include two opposing sidewalls, each having a first arcuate region adjacent to the first landing, a second arcuate region adjacent to the second landing, and a third arcuate region adjacent to the third landing. The arcuate regions can provide the landings with diameters adapted to enclose the respective gears positioned thereon, in a manner that permits rotation of each gear relative to the respective region within which it is enclosed.

In an embodiment, the first gear can include a lower portion associated with the first landing, a vertical gear engaged with the shaft (e.g., with a corresponding gear thereon), a horizontal gear engaged with the second gear, and a top portion extending through the first orifice to engage the first rotatable component. The second gear can include a lower portion associated with the second landing, a horizontal gear engaged with the first and third gears, and a top portion extending through the second orifice to engage the second rotatable component. The third gear can include a lower portion associated with the third landing, a horizontal gear engaged with the second gear, and a top portion extending through the third orifice to engage the third rotatable component. The vertical gear (on the first gear) can include an angled surface, while the shaft includes a complementary angled gear surface parallel to the angled surface of the vertical gear.

In an embodiment, the first landing can include a height less than that of the second and/or third landings (e.g., to accommodate engagement between the shaft and the first gear). Each of the gears can include a spacing region positioned between the lower portions and horizontal gears thereof, e.g., to position the horizontal gears in alignment with one another. The spacing regions can be sized to have a dimension (e.g., a diameter) greater than that of the corresponding orifice in the associated landing.

While any manner of rotatable component can be associated with the gears, in an embodiment, one or more of the rotatable components can include a bristle assembly having a base section with an orifice removably engaged with the top portion of a gear, and an upper section having a plurality of bristle members extending therefrom. For example, in an embodiment, a mounting region of the bristle assembly can include concentric circles of bristle members, with an unobstructed, generally flat region at the center thereof (e.g., a region lacking bristles).

Alternatively or additionally, one or more of the rotatable components can include a floss assembly engaged with a gear and having a plurality of floss members extending therefrom. Floss members can include thin strands of any generally rigid, bendable/pliable material (e.g., plastic, composite, resin, nylon, rubber, one or more polymers, etc.) less flexible along a first axis (e.g., a longitudinal axis) than along an alternate axis (e.g., axes non-parallel to the first axis.) In an embodiment, the floss members can define an upper surface having a generally flat region between two arcuate regions. The upper surface can be angled.

In an embodiment, a handle can be associated with the neck portion, the handle having upper and lower portions defining a space between. At least one of the portions can include a dividing wall extending therefrom that divides the space into a first chamber and a second chamber, e.g., usable for accommodating a motor, one or more power sources, etc.

### BRIEF DESCRIPTION OF THE DRAWINGS

In the detailed description of various embodiments usable within the scope of the present disclosure, presented below, reference is made to the accompanying drawings, in which:

FIG. 1 depicts an assembly view of an embodiment of a toothbrush head usable within the scope of the present disclosure.

FIG. 2A depicts a perspective view of a lower body portion of the toothbrush head shown in FIG. 1.

FIG. 2B depicts a top view of the lower body portion of FIG. 2A.

FIG. 2C depicts a side view of the lower body portion of FIG. 2A.

FIG. 2D depicts a side, cross-sectional view of the lower body portion of FIG. 2A.

FIG. 2E depicts a rear view of the lower body portion of FIG. 2A.

FIG. 3A depicts a perspective view of an upper body portion of the toothbrush head shown in FIG. 1.

FIG. 3B depicts a bottom view of the upper body portion of FIG. 3A.

FIG. 3C depicts a side view of the upper body portion of FIG. 3A.

FIG. 3D depicts a side, cross-sectional view of the upper body portion of FIG. 3A.

FIG. 3E depict a rear view of the upper body portion of FIG. 3A.

FIG. 4A depicts a perspective view of the upper and lower body portions of the toothbrush head shown in FIG. 1.

FIG. 4B depicts a top view of the body portions of FIG. 4A.

FIG. 4C depicts a side view of the body portions of FIG. 4A.

FIG. 5A depicts a side view of a shaft of the toothbrush head shown in FIG. 1.

FIG. 5B depicts a front end view of the shaft of FIG. 5A.

FIG. 5C depicts a rear view of the shaft of FIG. 5A.

FIG. 6A depicts a perspective view of a first gear of the toothbrush head shown in FIG. 1.

FIG. 6B depicts a side view of the gear of FIG. 6A.

FIG. 6C depicts a bottom view of the gear of FIG. 6A.

FIG. 6D depicts a top view of the gear of FIG. 6A.

FIG. 7A depicts a perspective view of a second gear of the toothbrush head shown in FIG. 1.

FIG. 7B depicts a side view of the gear of FIG. 7A.

FIG. 7C depicts a bottom view of the gear of FIG. 7A.

FIG. 7D depicts a top view of the gear of FIG. 7A.

FIG. 8A depicts a perspective view of a third gear of the toothbrush head shown in FIG. 1.

FIG. 8B depicts a side view of the gear of FIG. 8A.

FIG. 8C depicts a bottom view of the gear of FIG. 8A.

FIG. 8D depicts a top view of the gear of FIG. 8A.

FIG. 9A depicts a perspective view of a bristle base and/or rotating component of the toothbrush head shown in FIG. 1.

FIG. 9B depicts a bottom view of the component of FIG. 9A.

FIG. 9C depicts a side view of the component of FIG. 9A.

FIG. 9D depicts a side, cross-sectional view of the component of FIG. 9A.

FIG. 10A depicts an assembly view of an embodiment of a toothbrush head usable within the scope of the present disclosure.

FIG. 10B depicts an assembled, perspective view of the toothbrush head of FIG. 10A.

FIG. 11A depicts a perspective view of a lower body portion of the toothbrush head shown in FIG. 10A.

FIG. 11B depicts a side, cross-sectional view of the lower body portion of FIG. 11A.

FIG. 11C depicts a rear view of the lower body portion of FIG. 11A.

FIG. 12A depicts a perspective view of an upper body portion of the toothbrush head shown in FIG. 10A.

FIG. 12B depicts a top view of the upper body portion of FIG. 12A.

FIG. 12C depicts a side view of the upper body portion of FIG. 12A.

FIG. 12D depicts a rear view of the upper body portion of FIG. 12A.

FIG. 13A depicts a perspective view of a shaft of the toothbrush head shown in FIG. 10A.

FIG. 13B depicts a side view of the shaft of FIG. 13A.

FIG. 13C depicts a front end view of the shaft of FIG. 13A.

FIG. 14A depicts a perspective view of a first gear of the toothbrush head shown in FIG. 10A.

FIG. 14B depicts a side view of the gear of FIG. 14A.

FIG. 14C depicts a top view of the gear of FIG. 14A.

FIG. 14D depicts a bottom view of the gear or FIG. 14A.

FIG. 15A depicts a perspective view of a second gear of the toothbrush head shown in FIG. 10A.

FIG. 15B depicts a side view of the gear of FIG. 15A.

FIG. 15C depicts a top view of the gear of FIG. 15A.

FIG. 16A depicts a perspective view of a bristle component of the toothbrush head shown in FIG. 10A.

FIG. 16B depicts a side view of the bristle component of FIG. 16A.

FIG. 16C depicts a top view of the bristle component of FIG. 16A.

FIG. 16D depicts a side, cross-sectional view of the bristle component of FIG. 16A.

FIG. 17A depicts a perspective view of an embodiment of toothbrush usable within the scope of the present disclosure and incorporating the toothbrush head shown in FIG. 10A.

FIG. 17B depicts a side view of the toothbrush of FIG. 17A.

FIG. 17C depicts a side, cross-sectional view of the toothbrush of FIG. 17A.

FIG. 18A depicts a perspective view of a lower handle portion of the toothbrush shown in FIG. 17A.

FIG. 18B depicts a side, cross-sectional view of the lower handle portion of FIG. 18A.

FIG. 18C depicts a rear view of the lower handle portion of FIG. 18A.

FIG. 19A depicts a perspective view of an upper handle portion of the toothbrush shown in FIG. 17A.

FIG. 19B depicts a side, cross-sectional view of the upper handle portion of FIG. 19A.

FIG. 20A depicts a perspective view of an embodiment of a floss component usable with toothbrush configurations within the scope of the present disclosure.

FIG. 20B depicts a side view of the floss component of FIG. 20A.

FIG. 20C depicts a top view of the floss component of FIG. 20A.

FIG. 20D depicts a side, cross-sectional view of the floss component of FIG. 20A.

FIG. 21A depicts a perspective view of an embodiment of a flat brushing component usable with toothbrush configurations within the scope of the present disclosure.

FIG. 21B depicts a top view of the flat brushing component of FIG. 21A.

FIG. 21C depicts a side, cross-sectional view of the flat brushing component of FIG. 21A.

One or more embodiments are described below with reference to the listed Figures.

### DETAILED DESCRIPTION OF THE EMBODIMENTS

Before describing selected embodiments of the present invention in detail, it is to be understood that the present invention is not limited to the particular embodiments described herein. The disclosure and description herein is illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents may be made without departing from the spirit of the invention.

As well, it should be understood the drawings are intended illustrate and plainly disclose presently preferred embodiments of the invention to one of skill in the art, but are not intended to be manufacturing level drawings or renditions of final products and may include simplified conceptual views as desired for easier and quicker understanding or explanation of the invention. As well, the relative size and arrangement of the components may differ from that shown and still operate within the spirit of the invention as described throughout the present application.

Moreover, it will be understood that various directions such as “upper”, “lower”, “bottom”, “top”, “left”, “right”, and so forth are made only with respect to explanation in conjunction with the drawings, and that the components may be oriented differently, for instance, during transportation and manufacturing as well as operation. Because many varying and different embodiments may be made within the scope of the inventive concept(s) herein taught, and because many modifications may be made in the embodiments described herein, it is to be understood that the details herein are to be interpreted as illustrative and non-limiting.

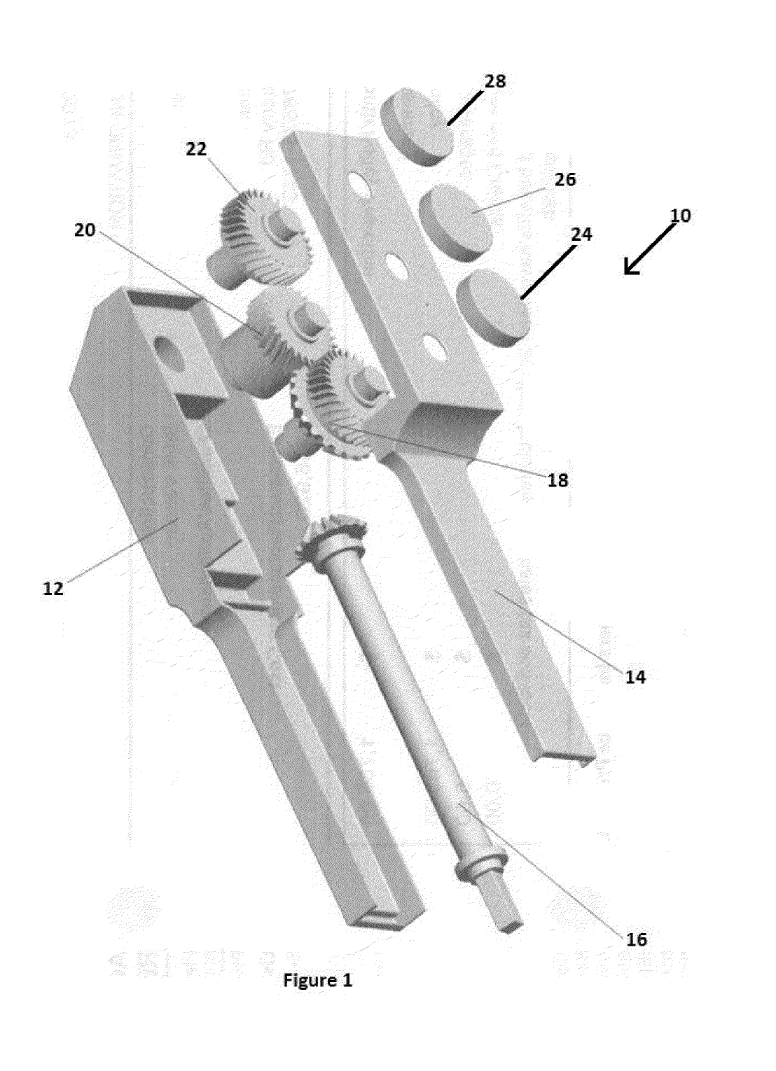

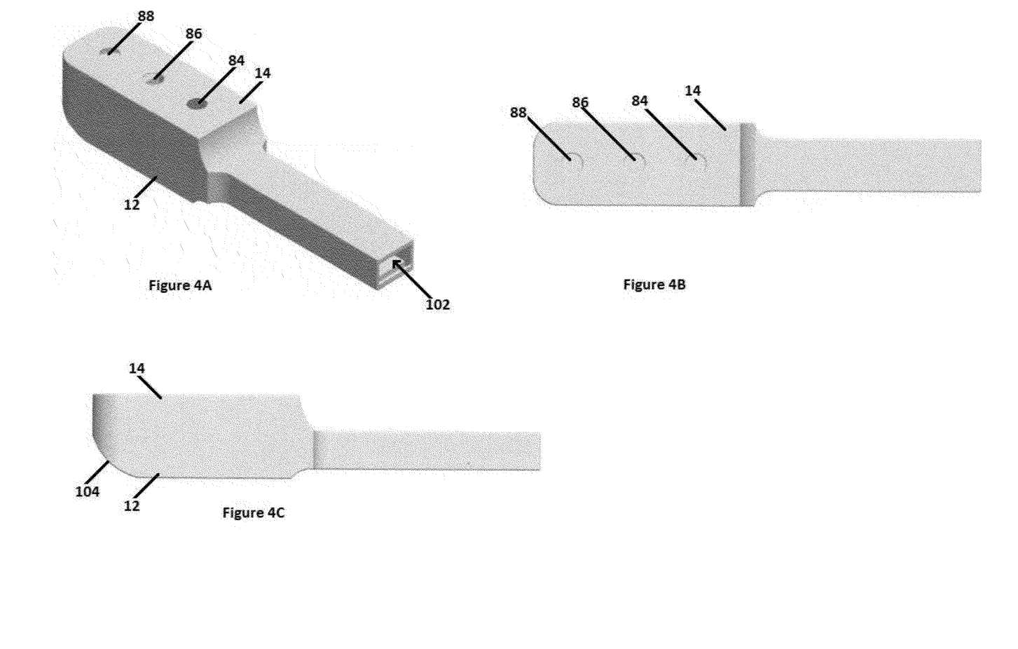

FIG. 1 depicts an assembly view of an embodiment of a configuration for a toothbrush head (10) usable within the scope of the present disclosure. The toothbrush head (10) includes, generally, a housing formed from a lower body portion (12) and an upper body portion (14), which can be engaged to form an assembled housing (e.g., as depicted in FIGS. 4A through 4C). The housing includes a neck portion having a space (102, shown in FIG. 4A) that accommodates a shaft (16), and a head portion having spaces and/or landings shaped to accommodate three gears (18, 20, 22). When the toothbrush head (10) is assembled, a portion of each gear (18, 20, 22) can extend through the housing (e.g., the upper body portion (14) thereof, such as through holes and/or orifices formed therein), to engage rotatable components (24, 26, 28), which in various embodiments can include bristles, floss components, and/or other rotatable elements. In use, a motor (not shown) positioned in a handle portion (not shown) can be used to impart rotational motion to the shaft (16), which in turn causes rotation of the first gear (18) and the rotatable component (24) associated therewith. Rotation of the first gear (18) imparts rotational motion to the second gear (20) and the associated rotatable component (26), in the opposite rotational direction. Rotation of the second gear (20) imparts rotational motion to the third gear (22) and the associated rotatable component (28), in the same rotational direction as that of the first gear (18).

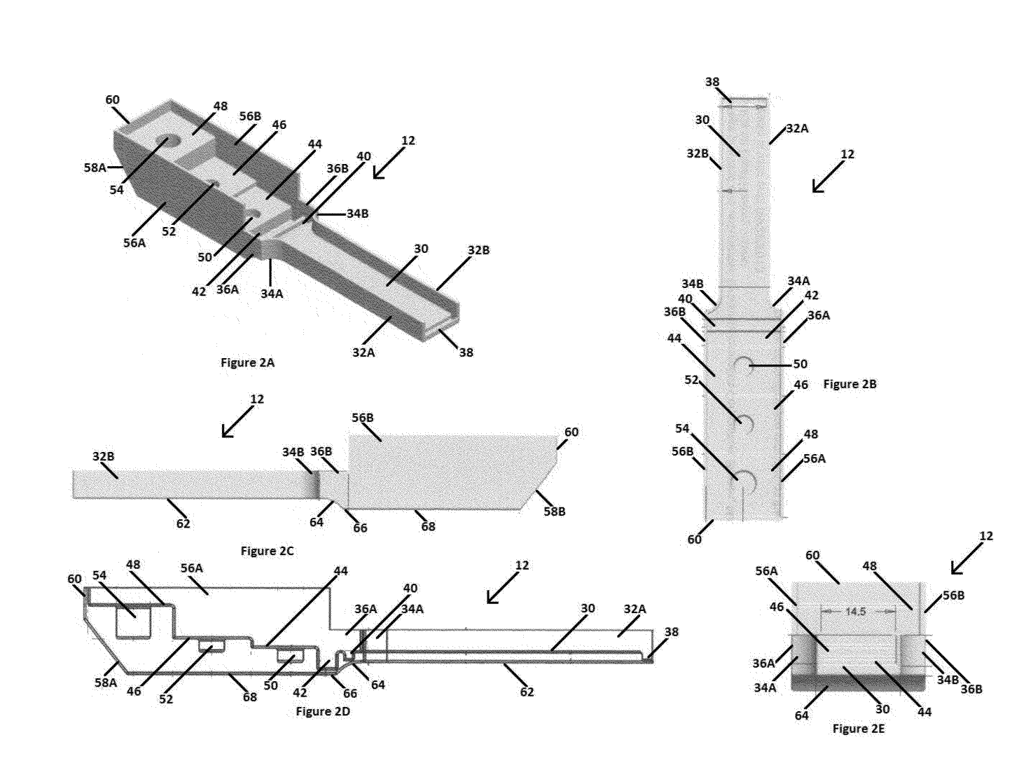

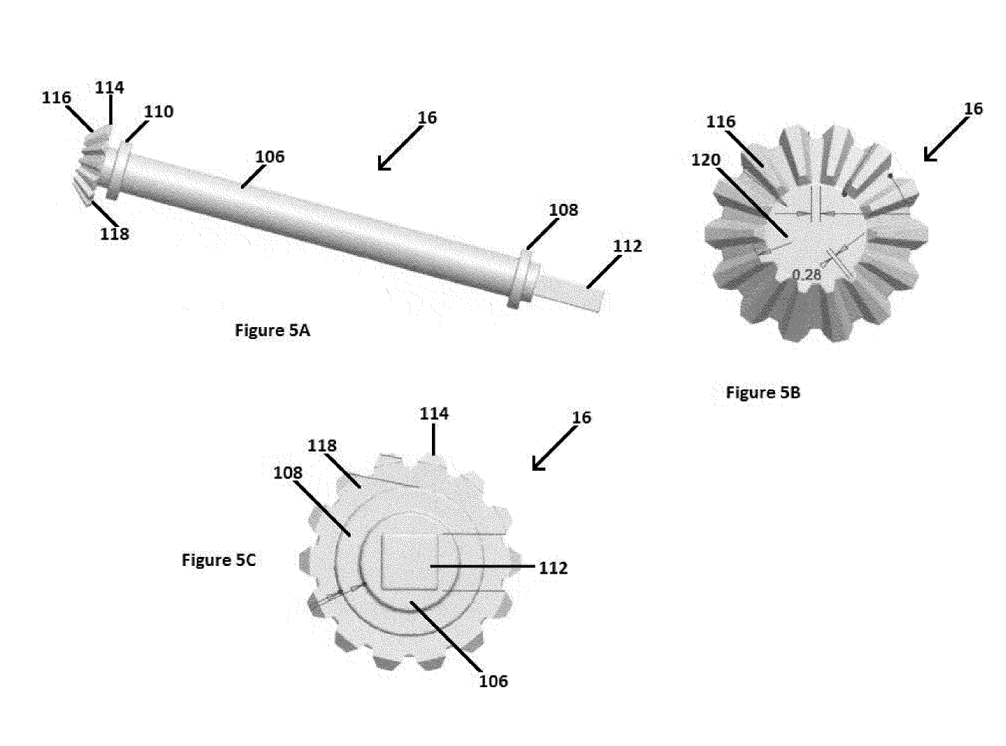

FIGS. 2A through 2E depict the lower body portion (12) of the toothbrush head (10, shown in FIG. 1). Specifically, FIG. 2A depicts a perspective view of the lower body portion (12), FIG. 2B depicts a top view, FIG. 2C depicts a side view, FIG. 2D depicts a side, cross-sectional view, and FIG. 2E depicts a rear view thereof. The neck portion of the lower body portion (12) is shown having a space (30) (for accommodating the shaft (16), shown in FIG. 1, as described above) the space (30) being defined by two opposing sidewalls (32A, 32B). Proximate to the point at which the neck portion meets the head portion, the sidewalls (32A, 32B) flare outward in opposing arcuate shoulders (34A, 34B), which terminate at additional sidewalls (36A, 36B), more widely spaced than the sidewalls (32A, 32B) that surround the space (30). The additional sidewalls (36A, 36B) define two spaced grooves (40, 42) therebetween (e.g., having a raised land, protrusion, and/or shoulder between the two grooves (40, 42)), the grooves (40, 42) being usable to accommodate protruding portions (e.g., elements 110 and 116, shown in FIG. 5A) of the shaft (16, shown in FIGS. 1 and 5A through 5C). A rear shoulder and/or landing (38) is similarly usable to accommodate a protruding portion (e.g., element 108, shown in FIG. 5A) of the shaft (16, shown in FIGS. 1 and 5A through 5C).

The head portion of the lower body portion (12) is shown having three landings (44, 46, 48), each having a respective orifice (50, 52, 54) (e.g., a groove, hole, recession, or similar feature) formed therein. As shown in FIGS. 2A and 2D, in the depicted embodiment, the first landing (44) has a height less than that of the second landing (46), which has a height less than that of the third landing (48). As shown in FIG. 2D, in the depicted embodiment, the second orifice (52) has a depth less than that of the first orifice (50), which has a depth less than that of the third orifice (54). As shown in FIGS. 2A and 2B, in the depicted embodiment, the first and second orifices (50, 52) have a diameter less than that of the third orifice (54). It should be understood that the position and size of the landings (44, 48, 50) and the position and size of the orifices (52, 54, 56) can be selected to accommodate features and/or dimensions of the gears (18, 20, 22, shown in FIG. 1) to be associated therewith. The landings (44, 46, 48) are shown positioned between two head sidewalls (56A, 56B), which terminate at angled front ends (58A, 58B), which in turn terminate at a generally vertical front wall (60). FIGS. 2C and 2D depict the underside of the lower body portion (12), illustrating that the space (30) within the neck portion thereof is further defined by a lower wall (62), which expands outward in an arcuate shoulder (64), terminating in a lower wall (66) beneath the grooves (40, 42), and further extending into a lower wall (68) beneath the landings (44, 46, 48), that angles upward (parallel to the angled front ends (58A, 58B)), then becomes vertical to define the front wall (60).

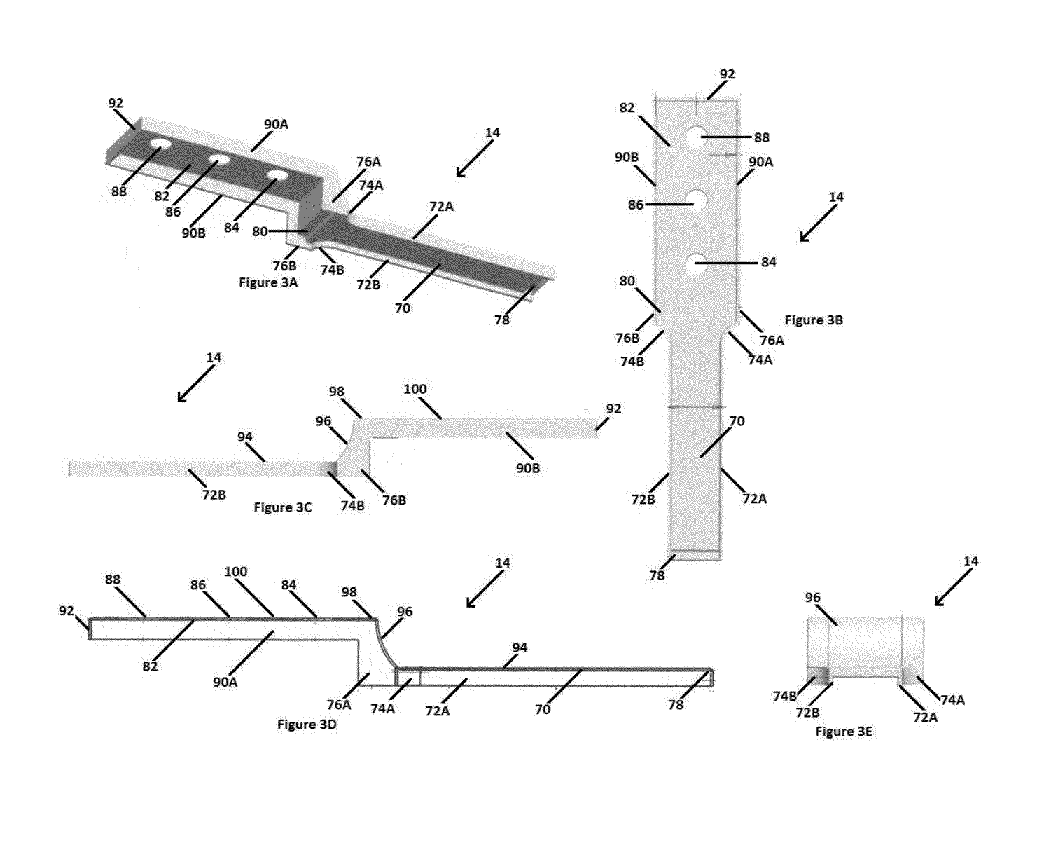

FIGS. 3A through 3E depict the upper body portion (14) of the toothbrush head (10, shown in FIG. 1). Specifically, FIG. 3A depicts a perspective view of the upper body portion (14), FIG. 3B depicts a bottom view, FIG. 3C depicts a side view, FIG. 3D depicts a side, cross-sectional view, and FIG. 3E depicts a rear view thereof. The neck portion of the upper body portion (14) is shown having a space (70) for accommodating the shaft (16, shown in FIG. 1), which, when assembled to form the housing for the toothbrush head (10, shown in FIG. 1), forms the unitary space (102, shown in FIG. 4A) in conjunction with the space (30, shown in FIG. 2A) in the lower body portion (12, shown in FIG. 2A). The space (70) is defined between two opposing sidewalls (72A, 72B), which, when assembled, abut the sidewalls (32A, 32B, shown in FIG. 2A) of the lower body portion (12, shown in FIG. 2A). The sidewalls (72A, 72B) expand outward at arcuate shoulders (74A, 74B), terminating at additional sidewalls (76A, 76B), between which a shoulder (80) is positioned for accommodating protruding portions of the shaft (16, shown in FIG. 1). When assembled, the shoulders (74A, 74B) and sidewalls (76A, 76B) abut the corresponding shoulders (34A, 34B, shown in FIG. 2A) and sidewalls (36A, 36B, shown in FIG. 2A) of the lower body portion (12, shown in FIG. 2A), while the shoulder (80) is positioned above the groove (42, shown in FIG. 2A). A rear shoulder (78) of the neck portion is usable to accommodate protruding portions of the shaft (16, shown in FIG. 1), in conjunction with the rear shoulder (38, shown in FIG. 2A) of the lower body portion (12, shown in FIG. 2A).

The head portion of the upper body portion (14) includes a space (82) bounded between two head sidewalls (90A, 90B) that terminate at a front wall (92), and a top wall (100), through which three orifices (84, 86, 88) are formed. When assembled, the space (82) forms a unitary space with the space above the landings (44, 46, 48, shown in FIG. 2A) of the lower body portion (12, shown in FIG. 2A), while the orifices (84, 86, 88) can be generally positioned to accommodate features of the gears (18, 20, 22, shown in FIG. 1) that extend through the orifices (84, 86, 88) to engage rotatable components. FIGS. 3C and 3D depict the top side of the upper body portion (14) including an upper wall (94) along the neck portion that bounds the space (70) in conjunction with the sidewalls (72A, 72B). The upper wall (96) terminates at an arcuate shoulder (96) that extends to meet an additional upper wall (98) positioned over the shoulder (80), which extends to become the top wall (100) of the head portion.

FIGS. 4A through 4C depict assembled views of the housing of the toothbrush head (10, shown in FIG. 1). Specifically, FIG. 4A depicts a perspective view of the housing, FIG. 4B depicts a top view, and FIG. 4C depicts a side view thereof. As described previously, the housing can be formed by engaging the lower body portion (12) with the upper body portion (14), to define a space (102) therebetween. In the depicted embodiment, the orifices (84, 86, 88) for accommodating protruding portions of gears are shown extending through the upper body portion (14). Also of note, in the depicted embodiment, the front end of the lower body portion (12) is shown having a curved shape (104), as a possible alternative to the angled front ends (58A, 58B) depicted in FIGS. 2A, 2C, and 2D. The upper and lower body portions (12, 14) can be engaged to one another using any manner of adhesive, fastener, or fastening method (e.g., interlocking/snapping/locking components, welding, heat sealing/pressing, etc.). While upper and lower body portions (12, 14) are shown, it should be understood that in various embodiments, the housing could be provided as a unitary component, and in various other embodiments, the housing could include more than two portions.

FIGS. 5A through 5C depict the shaft (16) of the toothbrush head (10, shown in FIG. 1). Specifically, FIG. 5A depicts a side view of the shaft (16), FIG. 5B depicts a front end view, and FIG. 5C depicts a rear view thereof. The shaft (16) is shown having a generally cylindrical body (106) with two protruding guide shoulders (108, 110) positioned proximate to the ends thereof. When the toothbrush head is assembled, the rear guide shoulder (108) can be positioned within the rear shoulder (38, shown in FIG. 2A) of the lower body portion (12, shown in FIG. 2A) and the rear shoulder (78, shown in FIG. 3A) of the upper body portion (14, shown in FIG. 3A). The front guide shoulder (108) can be positioned within the first groove (40, shown in FIG. 2A) in the lower body portion (12, shown in FIG. 2A) and the shoulder (80, shown in FIG. 3A) in the upper body portion (14, shown in FIG. 3A). An end piece (112) with a square profile is shown extending form the rear end of the shaft (16) and is usable to engage a corresponding component of a motor and/or a shaft/extension thereof (e.g., an orifice or recession having a complementary square profile), such that actuation of the motor imparts rotation to the shaft (16) by applying rotational force to the end piece (112). The front end of the shaft (16) is shown having an angled gear (114), e.g., having an angled front face (116) with teeth thereon and a generally flat rear face (118). In use, the angled gear (114) can engage the first gear (18, shown in FIG. 1) of the toothbrush head (10, shown in FIG. 1) for imparting movement thereto through engagement between the teeth of the angled gear (114) and those of a portion of the first gear (18, shown in FIG. 1). As shown in FIG. 5B, in the depicted embodiment, the front end of the angled gear (114) can include a generally flat nose (120) at the approximate center thereof. When assembled, the second groove (42, shown in FIG. 2A) of the lower body portion (12, shown in FIG. 2A), and an opposing space in the upper body portion (14, shown in FIG. 3A) can accommodate the position of the angled gear (114), while the space (102, shown in FIG. 4A) in the housing can accommodate the body (106) of the shaft (16).

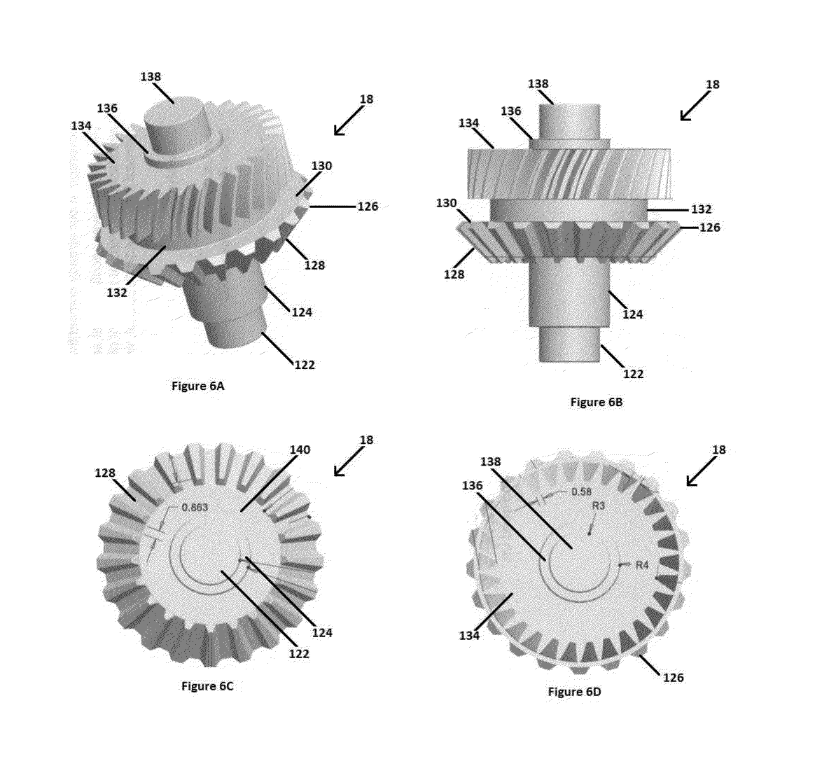

FIGS. 6A through 6D depict the first gear (18) of the toothbrush head (10, shown in FIG. 1). Specifically, FIG. 6A depicts a perspective view of the first gear (18), FIG. 6B depicts a side view, FIG. 6C depicts a bottom view, and FIG. 6D depicts a top view thereof. The first gear (18) is shown having an insertion portion (122), sized for insertion into the first orifice (50, shown in FIG. 2A) in the first landing (44, shown in FIG. 2A) of the lower body portion (12, shown in FIG. 2A). Specifically, the insertion portion (122) can have a diameter sized to fit generally closely within the first orifice (50, shown in FIG. 2A), while possessing sufficient clearance/tolerance to allow rotation of the first gear (18) relative to the remainder of the toothbrush head. Alternatively or additionally, the length of the insertion portion (122) can be sized to position the first gear (18) within the first orifice (50, shown in FIG. 2A) at a height relative to other components of the toothbrush head that enables operation thereof. In the depicted embodiment, a spacing portion (124) is shown positioned above the insertion portion (122), the spacing portion (124) having a diameter larger than that of the insertion portion (122) and the corresponding first orifice (50, shown in FIG. 2A), such that when assembled, the lower end of the spacing portion (124) can contact and/or be positioned proximate to the first landing (44, shown in FIG. 2A). The length/height of the spacing portion (124) and/or that of the insertion portion (122) can be sized to position the other portions of the first gear (18) appropriately relative to the second and third gears (20, 22, shown in FIG. 1) and the upper body portion (14, shown in FIG. 1), as described above and below.

An angled gear (126) is shown positioned above the spacing portion (124), the angled gear (126) having an angled bottom face (128) and a generally flat top face (130). When assembled, the angled gear (126) is generally perpendicular to the shaft (16, shown in FIG. 1) and the angled gear (114, shown in FIG. 5A) thereon, such that the angled bottom face (128) of the angled gear (126) is generally parallel to and engage the angled face (116, shown in FIG. 5A) if the angled gear (114, shown in FIG. 5A) of the shaft (16, shown in FIG. 5A). As such, rotation of the shaft (16, shown in FIG. 5A) in a direction generally parallel to the vertical axis of the first gear (18) can impart rotational movement to the first gear (18) in a direction generally perpendicular to the vertical axis thereof. An additional spacing section (132) is shown above the angled gear (126), above which a horizontal gear (134) is positioned. In use, the horizontal gear (134) of the first gear (18) engages corresponding components of the second gear (20, shown in FIG. 1) to impart (e.g., transmit and/or transfer) rotational force thereto. An upper shoulder (136) and a protruding top member (138) are shown above the horizontal gear (134). The top member (138) is sized such that when the toothbrush head (10, shown in FIG. 1) is assembled, the top member (138) protrudes through a corresponding orifice in the upper body portion (14, shown in FIG. 1). Rotatable components, such as bristles, can thereby be engaged with the top member (138), such that rotation of the first gear (18) causes rotation of an associated rotatable component, in addition to imparting movement to adjacent gear(s). Bearing surfaces can be provided at any points of contact (e.g., between the spacing portion (124) and an adjacent landing, between the upper shoulder (136) and the housing, and/or between the top member (138) and a corresponding rotatable component) where relative rotation may occur.

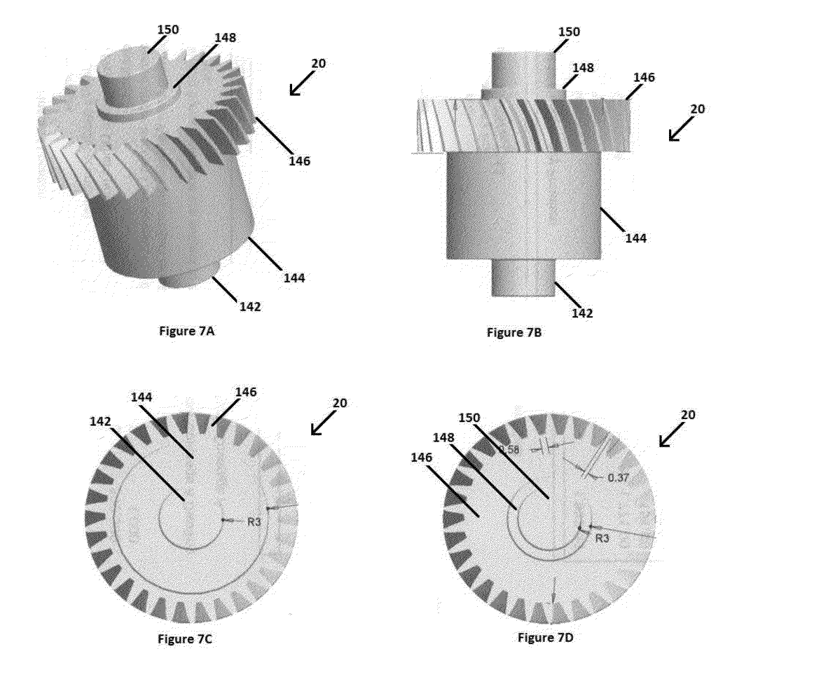

FIGS. 7A through 7D depict the second gear (20) of the toothbrush head (10, shown in FIG. 1). Specifically, FIG. 7A depicts a perspective view of the second gear (20), FIG. 7B depicts a side view, FIG. 7C depicts a bottom view, and FIG. 7D depicts a top view thereof. The second gear (20) is shown having an insertion portion (142), which can have a diameter sized to pass within the second orifice (52, shown in FIG. 2A) in the lower body portion (12, shown in FIG. 2A) while allowing rotation thereof. A spacing portion (144) is disposed above the insertion portion (142), the spacing portion (144) having a diameter greater than that of the insertion portion (142) and the second orifice (52, shown in FIG. 2A). A horizontal gear (146) is shown above the spacing portion (144). The length of the insertion portion (142) and/or the spacing portion (144) can be selected such that the horizontal gear (146) is at a height suitable for engagement with corresponding portions of the first and third gears (18, 22, shown in FIG. 1). An upper shoulder (148) and a protruding top member (150) are shown above the horizontal gear (146). The top member (150) is sized such that when the toothbrush head (10, shown in FIG. 1) is assembled, the top member (150) protrudes through a corresponding orifice in the upper body portion (14, shown in FIG. 1). Rotatable components, such as bristles, can thereby be engaged with the top member (150), such that rotation of the second gear (20) causes rotation of an associated rotatable component, in addition to imparting movement to adjacent gear(s). Bearing surfaces can be provided at any points of contact (e.g., between the spacing portion (144) and an adjacent landing, between the upper shoulder (148) and the housing, and/or between the top member (150) and a corresponding rotatable component) where relative rotation may occur. In use, the horizontal gear (134, shown in FIG. 6A) of the first gear (18, shown in FIG. 6A) engages the horizontal gear (146) of the second gear (20) to impart rotational movement thereto, in a direction opposite that of the first gear (18, shown in FIG. 6A), and the second gear (20) in turn engages corresponding components of the third gear (22, shown in FIG. 1) to impart (e.g., transmit and/or transfer) rotational force thereto.

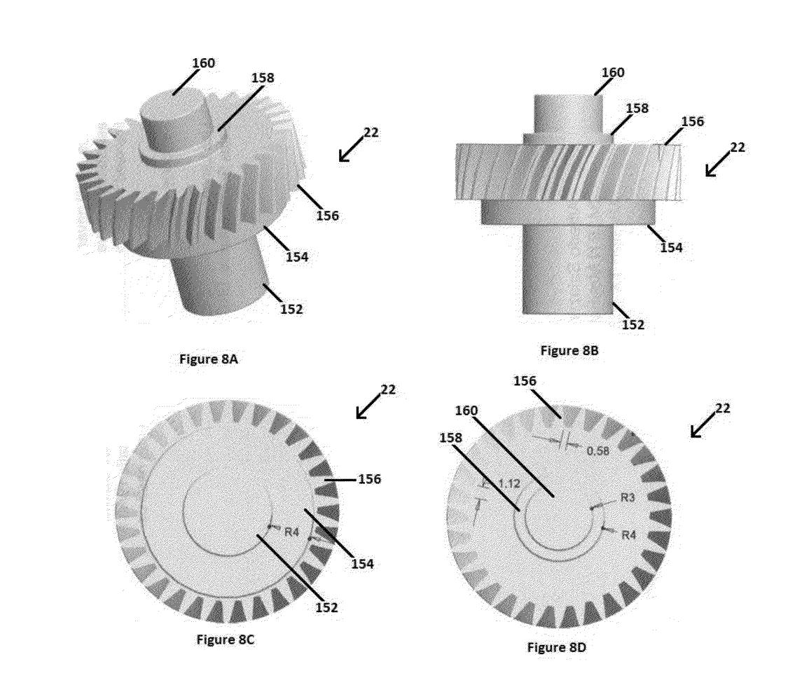

FIGS. 8A through 8D depict the third gear (22) of the toothbrush head (10, shown in FIG. 1). Specifically, FIG. 8A depicts a perspective view of the third gear (22), FIG. 8B depicts a side view, FIG. 8C depicts a bottom view, and FIG. 8D depicts a top view thereof. The third gear (22) is shown having an insertion portion (152), which can have a diameter sized to pass within the third orifice (54, shown in FIG. 1) of the lower body portion (12, shown in FIG. 1), while allowing rotation of the gear (22) relative to the housing. A spacing portion (154) is shown above the insertion portion (152), the spacing portion having a diameter larger than that of the insertion portion (152) and the third orifice (54, shown in FIG. 1). A horizontal (156) gear is disposed above the spacing portion (154). The length of the insertion portion (152) and/or the spacing portion (154) can be sized such that the horizontal gear (156) is positioned at a height suitable for engagement with corresponding portions of the first and second gears (18, 20, shown in FIG. 1). An upper shoulder (158) and a protruding top member (160) are shown above the horizontal gear (156). The top member (160) is sized such that when the toothbrush head (10, shown in FIG. 1) is assembled, the top member (160) protrudes through a corresponding orifice in the upper body portion (14, shown in FIG. 1). Rotatable components, such as bristles, can thereby be engaged with the top member (160), such that rotation of the third gear (22) causes rotation of an associated rotatable component. Bearing surfaces can be provided at any points of contact (e.g., between the spacing portion (154) and an adjacent landing, between the upper shoulder (158) and the housing, and/or between the top member (160) and a corresponding rotatable component) where relative rotation may occur. In use, the horizontal gear (134, shown in FIG. 6A) of the first gear (18, shown in FIG. 6A) engages the horizontal gear (146, shown in FIG. 7A) of the second gear (20, shown in FIG. 7A) to impart rotational movement thereto, in a direction opposite that of the first gear (18, shown in FIG. 6A), and the second gear (20, shown in FIG. 7A) in turn engages the horizontal gear (156) of the third gear (22) to impart (e.g., transmit and/or transfer) rotational force thereto.

It should be understood that while FIGS. 5A through 8D depict three gears (18, 20, 22) having different configurations (e.g., the length and/or diameters of spacing and insertion components), corresponding to the height of the landings (44, 46, 48, shown in FIG. 2A) and depth and diameter of the orifices (50, 52, 54, shown in FIG. 2A) of the lower body portion (12, shown in FIG. 2A), in various embodiments, two or more of the gears could be substantially identical, as could two or more of the landings and/or orifices. Further, while FIGS. 5A through 8D depict gears having separate insertion and spacing portions, it should be understood that in various embodiments, a single portion of a gear could serve both functions. Similarly, while FIGS. 5A through 8D depict insertion and spacing portions beneath a horizontal gear, in various embodiments, spacing portions could be provided above the horizontal gear, as needed.

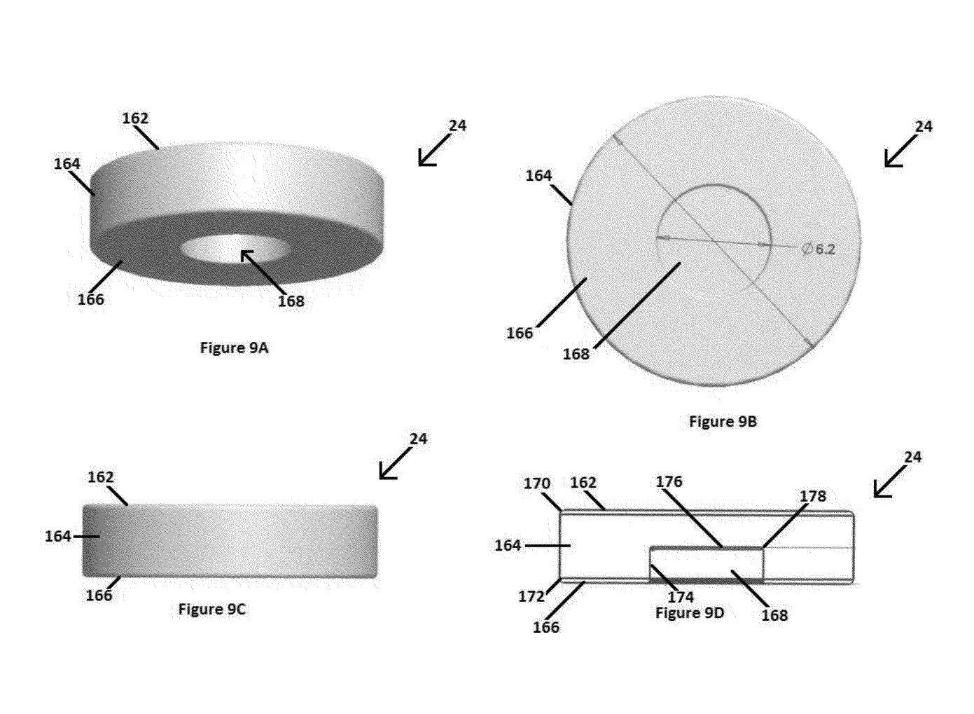

FIGS. 9A through 9D depict an embodiment of a rotatable component (24) usable with the toothbrush head (10) shown in FIG. 1. Specifically, FIG. 9A depicts a perspective view of the rotatable component (24), FIG. 9B depicts a bottom view, FIG. 9C depicts a side view, and FIG. 9D depicts a side, cross-sectional view thereof. The depicted rotatable component (24) is shown as a generally cylindrical, disc-shaped structure, which can be used as a cover, e.g., when a toothbrush is not in use, and/or which can be used to mount bristles, floss components, and/or other elements to be rotated through rotation of the underlying gears. It should be understood, however, that rotatable components of any shape, type, and/or dimension can be used without departing from the scope of the present disclosure, and the disc-shaped element shown in FIGS. 9A through 9D is a single exemplary embodiment. Specifically, the rotatable component (24) is shown having a generally flat top side (162), a cylindrical sidewall (164), and a generally flat underside (166) with a recession (168) formed therein. The recession (168) can be sized to accommodate a portion of an underlying gear (e.g., gears (18, 20, 22, shown in FIG. 1), such as the protruding top portions thereof, described previously. Engagement between the gear and the rotatable component (24) can include a force-fit and/or snap-fit, use of fasteners, adhesives, and/or other fastening methods. The depicted rotatable component (24) is shown having a curved, arcuate, and/or beveled top edge (170) at the intersection of the top side (162) and the sidewall (164), and a similar curved, arcuate, and/or beveled bottom edge (172) at the intersection of the underside (166) and the sidewall (164). The recession (168) is bounded by a generally cylindrical interior sidewall (174) and a top wall (176). In use, the rotatable component (24) can be generally fixedly attached to a gear (e.g., in a manner that limits relative movement therebetween), such that rotation of the underlying gear causes rotation of the rotatable component (24) and any additional elements (e.g., bristles and/or a bristle assembly) mounted and/or otherwise associated therewith. FIG. 1 depicts the embodied toothbrush head (10) having three generally identical rotatable components (24, 26, 28), and as such the second and third rotatable components (26, 28) are not independently depicted in greater detail; however, it should be understood that in various embodiments, rotatable components of differing sizes and/or types could be used without departing from the scope of the present disclosure.

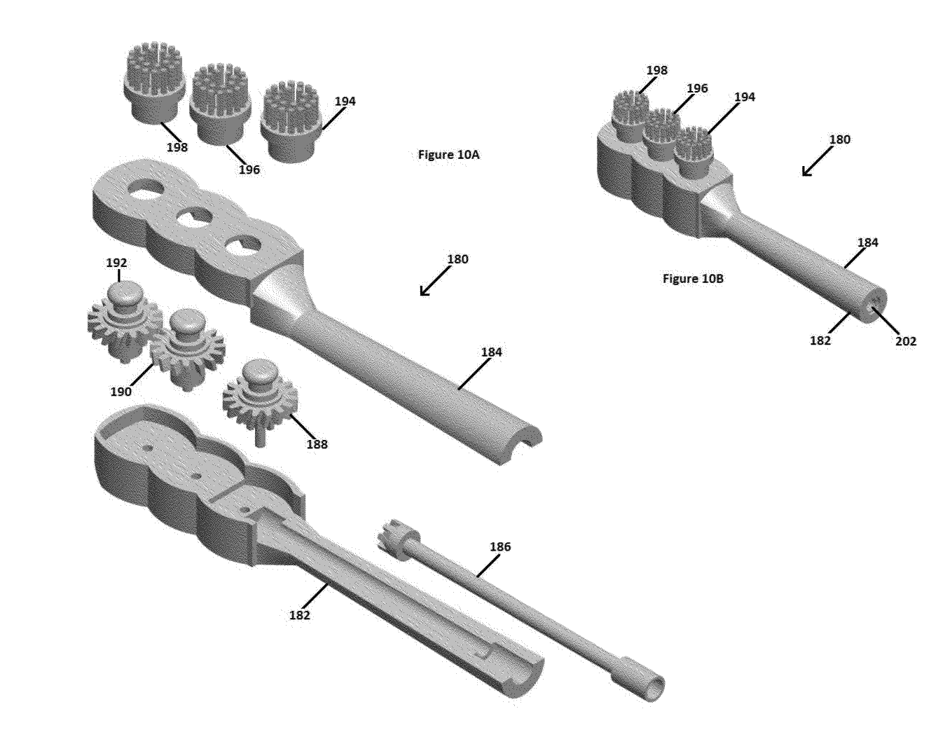

FIGS. 10A and 10B depict an embodiment of a configuration for a toothbrush head (180) usable within the scope of the present disclosure. Specifically, FIG. 10A depicts an assembly view of the toothbrush head (180), and FIG. 10B depicts an assembled, perspective view thereof. The depicted toothbrush head (180) includes, generally, a housing formed from a lower body portion (182) and an upper body portion (184), which can be engaged to form an assembled housing having a neck portion with a space (202) for accommodating a shaft (186), and a head portion having spaces and/or landings shaped to accommodate three gears (188, 190, 192). When the toothbrush head (180) is assembled, a portion of each gear (188, 190, 192) can extend through the housing (e.g., the upper body portion (184) thereof, such as through holes and/or orifices formed therein), to engage bristle assemblies (194, 196, 198) or other types of rotatable components. In use, a motor (not shown) positioned in a handle portion (not shown) can be used to impart rotational motion to the shaft (186), which in turn causes rotation of the first gear (188) and the first bristle assembly (194) associated therewith. Rotation of the first gear (188) imparts rotational motion to the second gear (190) and the associated bristle assembly (196), in the opposite rotational direction. Rotation of the second gear (190) imparts rotational motion to the third gear (192) and the associated bristle assembly (198), in the same rotational direction as that of the first gear (188).

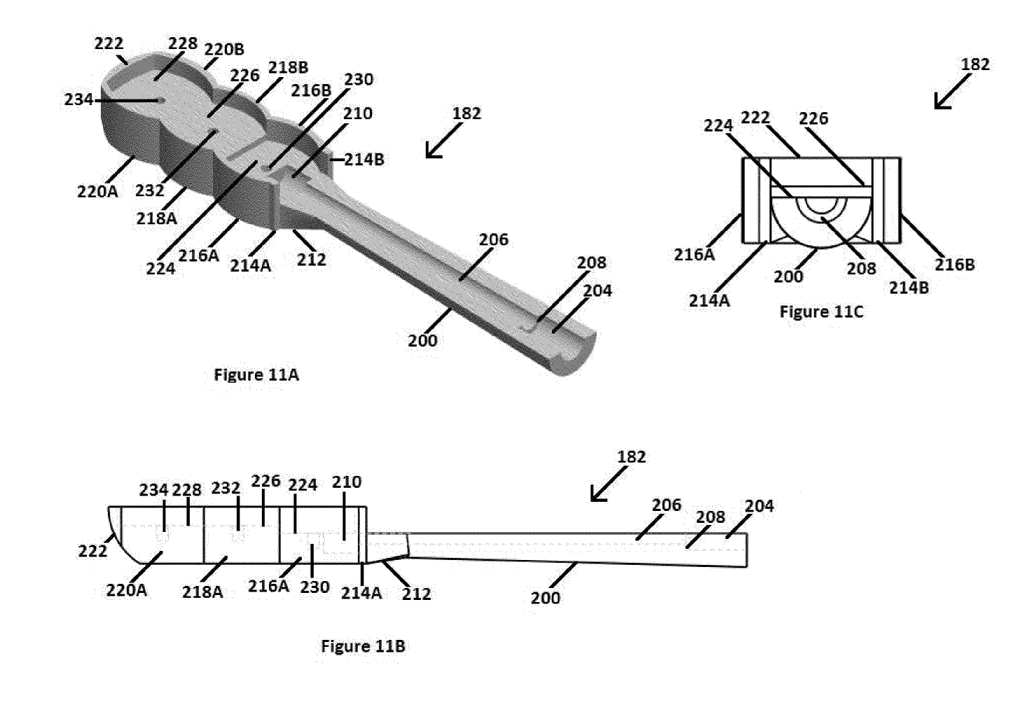

FIGS. 11A through 11C depict the lower body portion (182) of the toothbrush head (180) shown in FIG. 10A. Specifically, FIG. 11A depicts a perspective view of the lower body portion (182), FIG. 11B depicts a side, cross-sectional view, and FIG. 11C depicts a rear view thereof. The lower body portion (182) is shown having a neck portion with a generally cylindrical and/or conical body (200) having a first internal space (204) proximate to the end thereof and a narrower second internal space (206) (e.g. an axial bore) within. The first and second internal spaces (204, 206) are shown separated by an internal shoulder (208). A third internal space (210) is located at an end of the second internal space (206), at the point where the neck and head portions of the lower body portion (182) meet. In use, the first and third internal spaces (204, 210) are usable to accommodate wider portions of the shaft (186, shown in FIG. 10A), while the second internal space (206) accommodates a narrower portion thereof.

The body (200) of the neck portion flares outward at a conical taper (212) where the neck portion meets the head portion, terminating at opposing sidewalls (214A, 214B) positioned, approximately, on opposite sides of the third space (210). The head portion is defined/enclosed by a series of curved and/or arcuate sidewalls. Specifically, a first set of curved sidewalls (216A, 216B) are positioned on opposite sides of a first landing (224) having a first orifice (230) formed therein. A second set of curved sidewalls (218A, 218B) contiguous with the first set of sidewalls (216A, 216B) is positioned on opposite sides of a second landing (226) having a second orifice (232) formed therein. A third set of curved sidewalls (220A, 220B) contiguous with the second set of sidewalls (218A, 218B) is positioned on opposite sides of a third landing (228) having a third orifice (234) formed therein. The third set of sidewalls (220A, 220B) extend toward the distal end of the lower body portion (182) to meet and terminate at a front wall (222). In use, the orifices (230, 232, 234) and landings (224, 226, 228) are usable to accommodate the position of gears (188, 190, 192, shown in FIG. 10A). The curved shape of the sidewalls (214A, 214B, 216A, 216B, 218A, 218B) provides the head portion with three generally round regions about each landing (224, 226, 228), and in an embodiment, the regions can be sized to closely accommodate the gears (188, 190, 192, shown in FIG. 10A) while allowing rotation thereof.

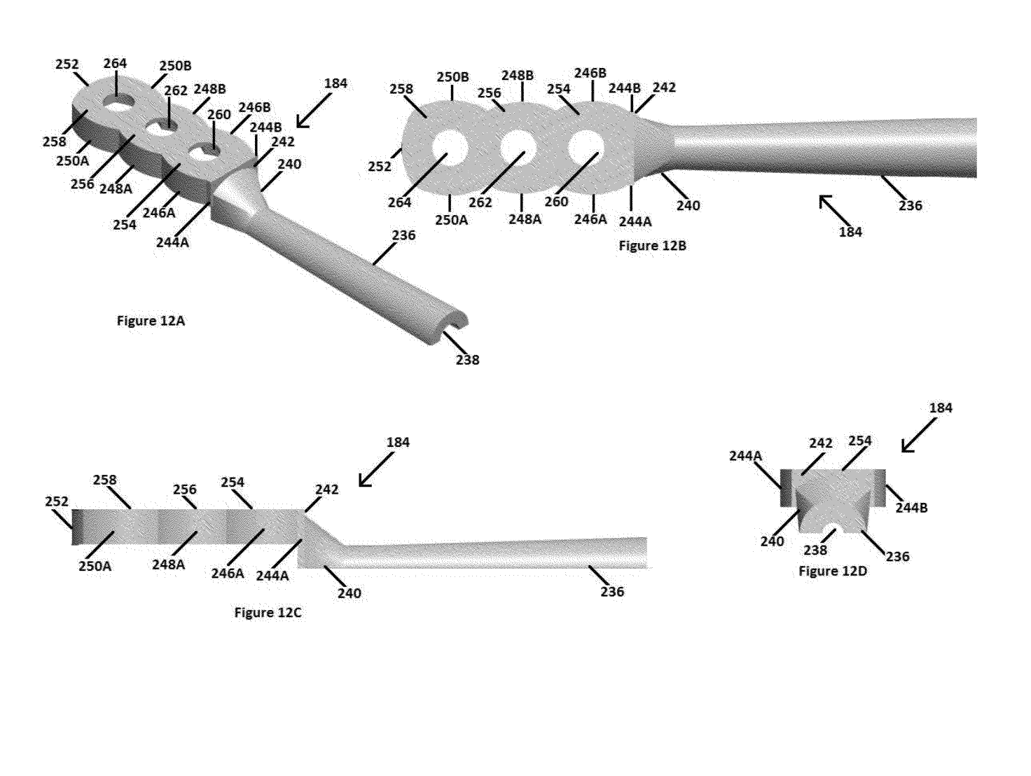

FIGS. 12A through 12D depict the upper body portion (184) of the toothbrush head (182) shown in FIG. 10A. Specifically, FIG. 12A depicts a perspective view of the upper body portion (184), FIG. 12B depicts a top view, FIG. 12C depicts a side view, and FIG. 12D depicts a rear view thereof. The upper body portion (184) includes a neck portion with a generally cylindrical and/or conical body (236) that defines a space (238) therein, which, when assembled, forms a unitary space (202, shown in FIG. 10B) when joined with the space (204, 206, shown in FIG. 11A) within the body (200, shown in FIG. 11A) of the lower body portion (182, shown in FIG. 11A). The body (236) expands outward with a conical taper (240) to meet a rear wall (242) of the head portion. The rear wall (242) abuts and is contiguous with two opposing sidewalls (244A, 244B). When assembled, the sidewalls (244A, 244B) generally align with the sidewalls (214A, 214B, shown in FIG. 11A) of the lower body portion (182, shown in FIG. 11A), while the conical taper (240) aligns with the conical taper (212, shown in FIG. 11A) of the lower body portion (182, shown in FIG. 11A).

The head portion is defined/enclosed by a series of curved and/or arcuate sidewalls. Specifically, a first set of curved sidewalls (246A, 246B) are positioned on opposite sides of a first upper face (254) a first orifice (260) formed therein. A second set of curved sidewalls (248A, 248B) contiguous with the first set of sidewalls (246A, 246B) is positioned on opposite sides of a second upper face (256) having a second orifice (262) formed therein. A third set of curved sidewalls (250A, 250B) contiguous with the second set of sidewalls (248A, 248B) is positioned on opposite sides of a third upper face (258) having a third orifice (264) formed therein. The third set of sidewalls (250A, 250B) extend toward the distal end of the upper body portion (184) to meet and terminate at a front wall (252). When assembled, the sidewalls (246A, 246B, 248A, 248B, 250A, 250B) align with and abut corresponding sidewalls (216A, 216B, 218A, 218B, 220A, 220B, shown in FIG. 11A) of the lower body portion (182, shown in FIG. 11A), such that the first upper face (254), the second upper face (256), and the third upper face (258) are positioned over the first, second and third landings (224, 226, 228, shown in FIG. 11A) of the lower body portion (182, respectively), such that gears positioned on the landings can extend into the orifices (260, 262, 264) of the upper body portion (184).

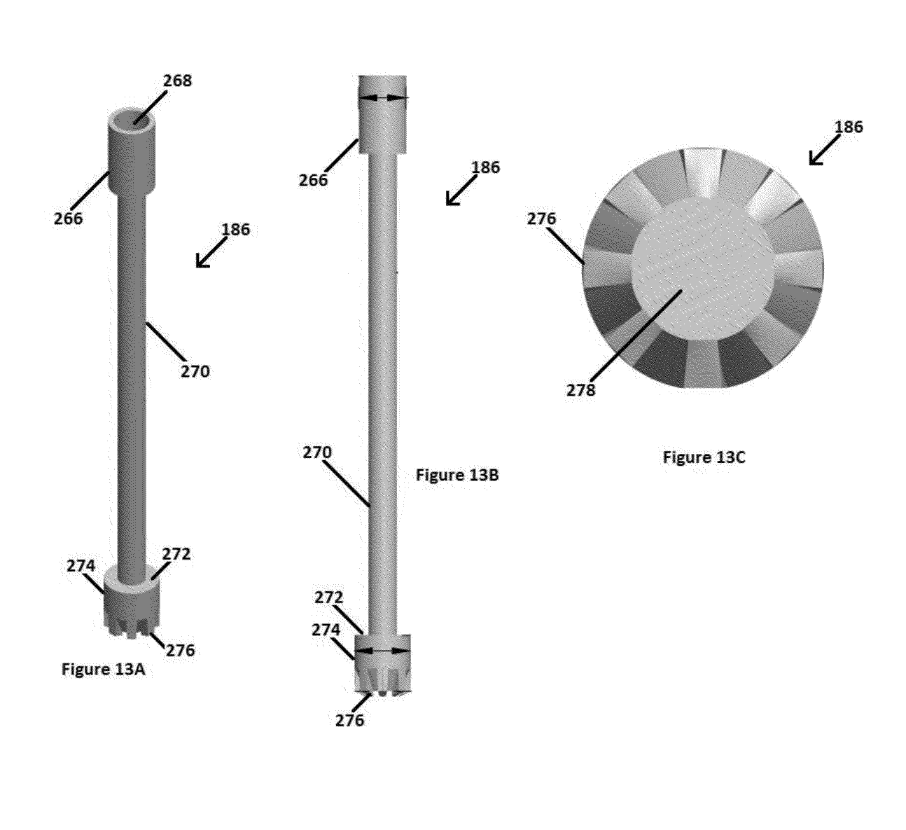

FIGS. 13A through 13C depict the shaft (186) of the toothbrush head (180) shown in FIG. 10A. Specifically, FIG. 13A depicts a perspective view of the shaft (186), FIG. 13B depicts a side view, and FIG. 13C depicts a front end view thereof. The shaft (186) is shown having a generally cylindrical body (170) with a widened end (266) having an orifice and/or bore (268) therein. In use, the bore (268) can engage a corresponding protruding portion of a motor, drive shaft, or similar driving and/or intermediate member to enable rotational movement from the motor to be imparted to the shaft (186). At the opposite end of the cylindrical body (170), a geared end (274) is shown, the geared end (274) including a generally cylindrical body, a rear shoulder (272), and teeth (276). As shown in FIG. 13C, the front face of the geared end (274) includes a generally flat central region (278). In use, the teeth (276) of the geared end (274) can engage and impart motion to the first gear (188, shown in FIG. 10A), which in turn imparts motion to other gears (190, 200, shown in FIG. 10A).

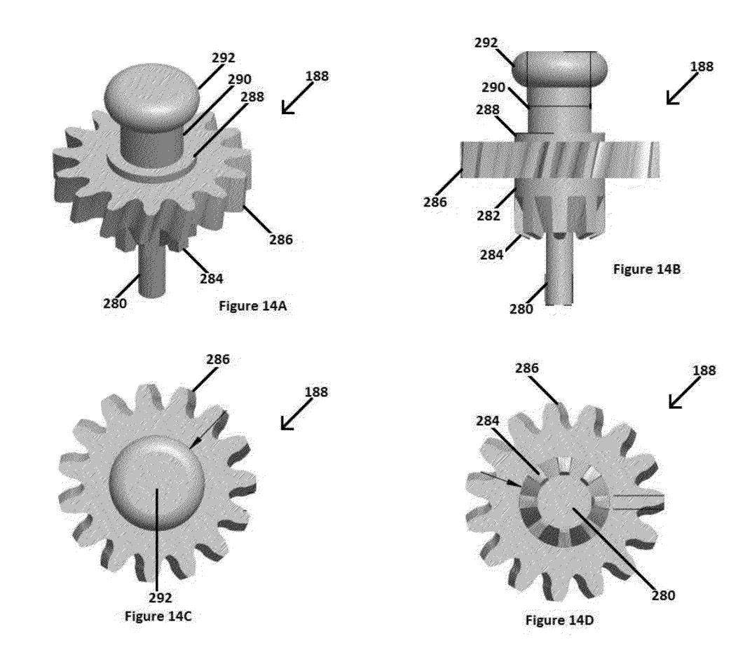

FIGS. 14A through 14D depict the first gear (188) of the toothbrush head (180) shown in FIG. 10A. Specifically, FIG. 14A depicts a perspective view of the first gear (188), FIG. 14B depicts a side view, FIG. 14C depicts a top view, and FIG. 14D depicts a bottom view thereof. The first gear (188) is shown having an insertion portion (280) at a lower end thereof, the insertion portion (280) being sized for passage within the first orifice (230, shown in FIG. 11A) of the lower body portion (182, shown in FIG. 11A). Specifically, in an embodiment, the insertion portion (280) can have a diameter slightly less than that of a corresponding orifice with which it is associated to allow rotation of the gear (188). The length of the insertion portion (280) can be selected such that other portions of the gear (188) are positioned appropriately (e.g., at a suitable height) for engagement with the shaft (186, shown in FIG. 10A) and the second gear (190, shown in FIG. 10A).

A vertical gear (282) having angled teeth (284) is shown formed about the insertion portion (280) toward the middle of the gear (188). A horizontal gear (286) is shown above the vertical gear (282). An upper shoulder (288) is shown above the horizontal gear (286), and a protruding top section that includes a top shaft (290) and a top end (292) is shown above the upper shoulder (288). The top shaft (290) is shown having a generally cylindrical shape, while the top end (292) is shown having a rounded, disc-like shape. The dimensions and/or shape of the top section can be selected for engagement with corresponding regions of a rotatable element (such as the bristle assemblies (194, 196, 198, shown in FIG. 10A)). In use, rotation of the vertical gear (282) via engagement with the shaft (186, shown in FIG. 10A) rotates the horizontal gear (286), which, in addition to imparting rotational movement to adjacent gears, causes rotation of the top section (290, 292) and any bristle assembly or other component(s) engaged therewith. Bearing surfaces and/or coatings can be used at points of contact between the first gear (188) and adjacent components to facilitate relative rotation thereof.

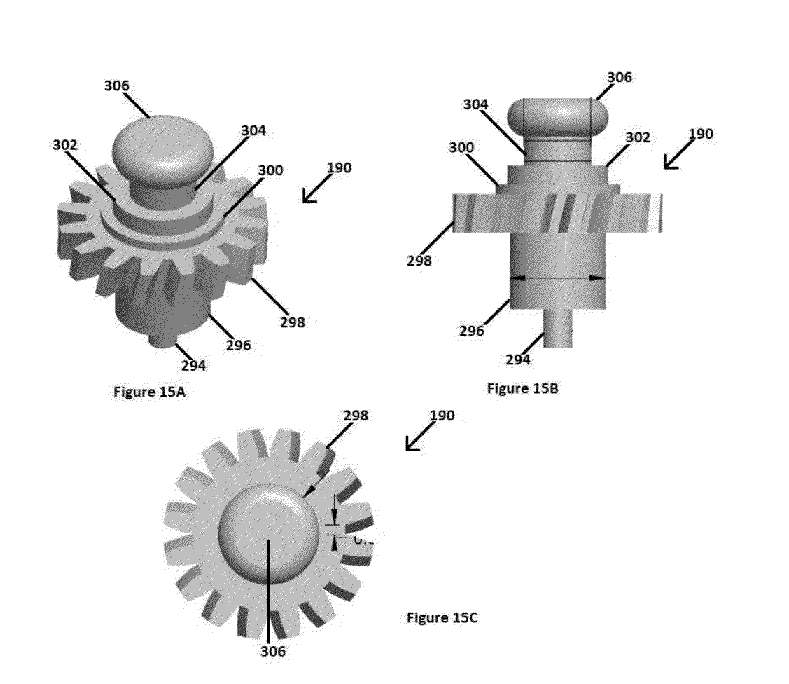

FIGS. 15A through 15C depict the second gear (190) of the toothbrush head (180, shown in FIG. 10A). Specifically, FIG. 15A depicts a perspective view of the second gear (190), FIG. 15B depicts a side view, and FIG. 15C depicts a top view thereof. The second gear (190) is shown having an insertion portion (294), which can be sized for passage within the second orifice (232, shown in FIG. 11A) of the lower body portion (182, shown in FIG. 11A). For example, the diameter of the insertion portion (294) can be slightly less than that of a corresponding orifice to facilitate rotation of the gear (190). A spacing portion (296) is shown above the insertion portion (294), the spacing portion having a diameter greater than that of the insertion portion (294) and the second orifice (232, shown in FIG. 11A). The length of the spacing portion (296) and/or the insertion portion (294) can be selected such that the second gear (190) is positioned at an appropriate height for engagement with the first and third gears (188, 192, shown in FIG. 10A).

A horizontal gear (298) is shown positioned above the spacing portion (296), and two upper shoulders (300, 302) are shown positioned above the horizontal gear (298). A top section that includes a generally cylindrical shaft (304) and a top end (306) having a rounded, disc-like shape is shown above the upper shoulders (300, 302). The dimensions and/or shape of the top section can be selected for engagement with corresponding regions of a rotatable element (such as the bristle assemblies (194, 196, 198, shown in FIG. 10A)). In use, rotation of the shaft (186, shown in FIG. 10A) can impart movement to the first gear (188, shown in FIG. 10A), which can in turn impart movement to the second gear (190) in a rotational direction opposite that of the first gear (188, shown in FIG. 10A). Movement of the second gear (190) can in turn impart movement to the third gear (192, shown in FIG. 10A) in a rotational direction opposite that of the second gear (190). Movement of the second gear (190) can further cause rotation of any bristle assembly or other component(s) engaged therewith (e.g., with the top section thereof). Bearing surfaces and/or coatings can be used at points of contact between the second gear (190) and adjacent components to facilitate relative rotation thereof.

FIG. 10A depicts the embodied toothbrush head (180) having a second gear (190) and third gear (192) of generally identical construction, and as such, the third gear (192) is not independently depicted in greater detail; however, it should be understood that in various embodiments, gears of differing sizes, shapes, configurations, and/or types could be used without departing from the scope of the present disclosure.

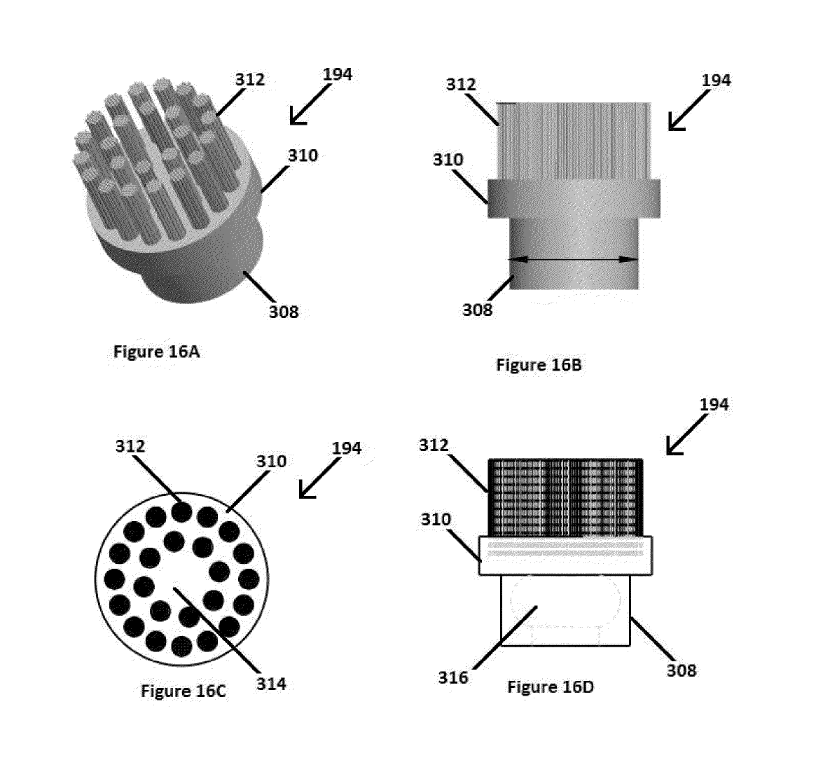

FIGS. 16A through 16D depict the first bristle assembly (194) of the toothbrush head (180) shown in FIG. 10A. Specifically, FIG. 10A depicts a perspective view of the bristle assembly (194), FIG. 10B depicts a side view, FIG. 10C depicts a top view, and FIG. 10D depicts a side, cross-sectional view thereof. The bristle assembly (194) is shown having a generally cylindrical base (308), a disc-shaped mounting platform (310) above the base (308), and a plurality of bristles (312) secured to the mounting platform (310). While FIGS. 16A through 16D depict the bristle assembly (194) as a generally unitary structure, in various embodiments, the bristles (312) could be removable and/or replaceable from the mounting platform (310), and/or the mounting platform (310) and associated bristles (312) could be removable and/or replaceable from the base (308). The bristle assembly (194) can be removably secured to the brush head (180, shown in FIG. 10A) through engagement of one of the gears (188, 190, 192, shown in FIG. 10A) thereof. For example, FIG. 16D depicts the bristle assembly (194) having an interior space (316) with a shape corresponding to that of the top portion (290, 292, 304, 306, shown in FIGS. 14A and 15A) of the gears (188, 190, 192, shown in FIG. 10A). The bristles (312) are shown arranged in two concentric circles, having a generally flat central region (314) therein, each of the sets of bristles being generally cylindrical in shape and equal in height; however, it should be understood that any size, shape, and configuration of bristles can be used without departing from the scope of the present disclosure. Engagement between the interior space (316) and corresponding portions of the gears can secure the bristle assembly (194) to the associated gear in a generally fixed orientation, such that rotation of the associated gear causes rotation of the bristle assembly (194).

FIG. 10A depicts the embodied toothbrush head (180) having three bristle assemblies (194, 196, 198) that are generally identical in construction, and as such, the second and third bristle assemblies (196, 198) are not depicted in greater detail; however, it should be understood that in various embodiments, bristle assemblies or other types of rotatable components, of differing sizes, shapes, configurations, and/or types could be used without departing from the scope of the present disclosure.

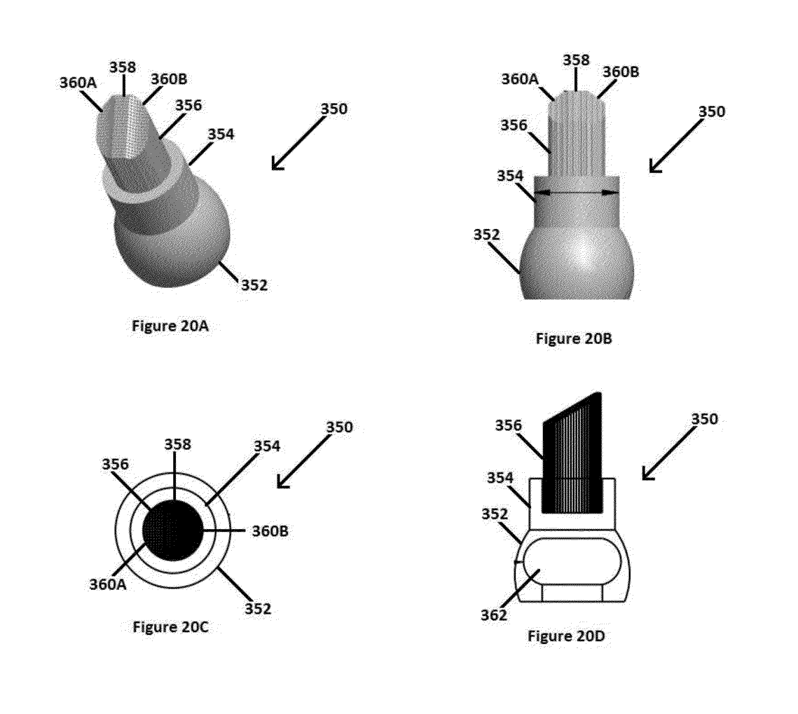

By way of example, FIGS. 20A through 20D depict an embodiment of a rotatable component usable with the toothbrush head (180) shown in FIG. 10A, e.g., that can be interchangeable with the depicted bristle assemblies (194, 196, 198). Specifically, the rotatable component is shown as a floss element (350), having features adapted for placement and/or movement between teeth and beneath a user's gum line. The depicted floss element (350) includes a base section (352), shown having a generally rounded shape, above which a generally cylindrical spacing section (354) is shown. An orifice (362) in the base section (352) is usable to engage the toothbrush head (e.g., via engagement with an upper portion of a gear thereof, as described previously). A plurality of closely-spaced, floss wires (356) is shown mounted in the spacing section (354) (e.g., within a bore therein), the depicted set of floss wires (356) having a generally cylindrical shape with an angled top. The top of the floss wires (356) is shown having a raised, generally flat/rectangular section (358) positioned between two curved and/or tapered sections (360A, 360B). The depicted configuration of the floss wires (356) can facilitate effective movement thereof between teeth and/or beneath a user's gum line; however, it should be understood that any shape, type, and/or configuration of elements could be used without departing from the scope of the present disclosure.

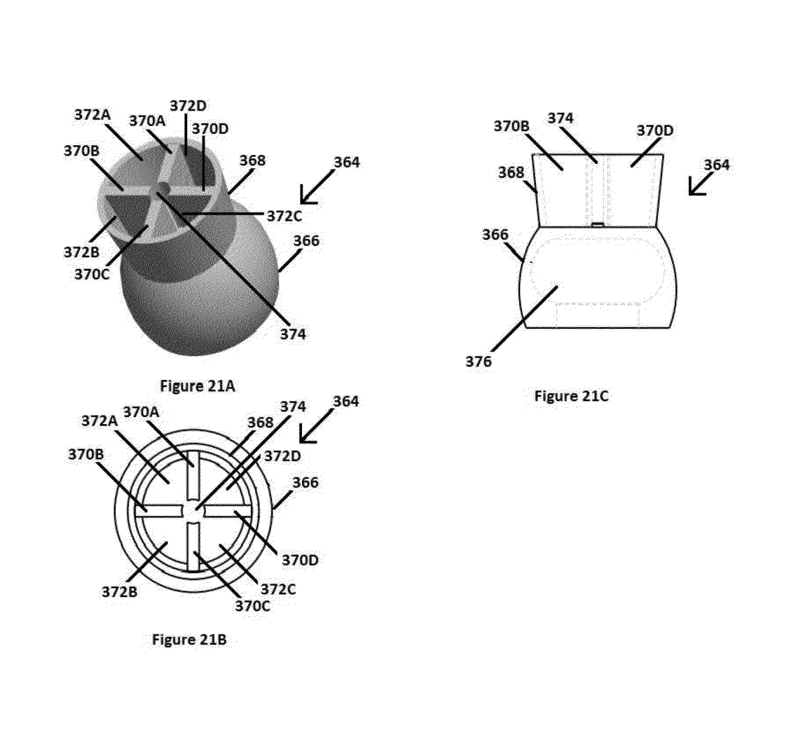

Similarly, FIGS. 21A through 21C depicts an embodiment of a rotatable component usable with the toothbrush head (180) shown in FIG. 10A, e.g., that can be interchangeable with the depicted bristle assemblies (194, 196, 198). Specifically, the rotatable component is shown as a flat brushing element (364), having features adapted for receiving an abrasive paste (e.g., such as a toothpaste similar to that used by dentists to polish teeth) and rotating in a manner adapted to contact teeth with such a composition. The flat brushing element (364) is shown having a rounded base section (366) with an orifice (376) therein for engagement with the toothbrush head (e.g., via engagement with an upper portion of a gear thereof, as described previously). An upper, tapered and/or frustoconical section (368) is shown above the base section (366). The upper section (368) is generally hollow and includes an interior chamber having four dividing walls (370A, 370B, 370C, 370D) equally spaced about the inner circumference thereof to divide the chamber into four wedge-shaped spaces (372A, 372B, 372C, 372D). The dividing walls (370A, 370B, 370C, 370D) are shown having a length less than that of the radius of the upper section (368), and arcuate inner edges, thereby defining a central region (374) between the wedge-shaped spaces (372A, 372B, 372C, 372D). In use, an abrasive paste or other desired compound can be placed within the central region (374) and/or spaces (327A, 372B, 372C, 372D), or on top of the upper section (368), such that rotation of the flat brushing element (364) can be used to movably contact teeth with the compound.

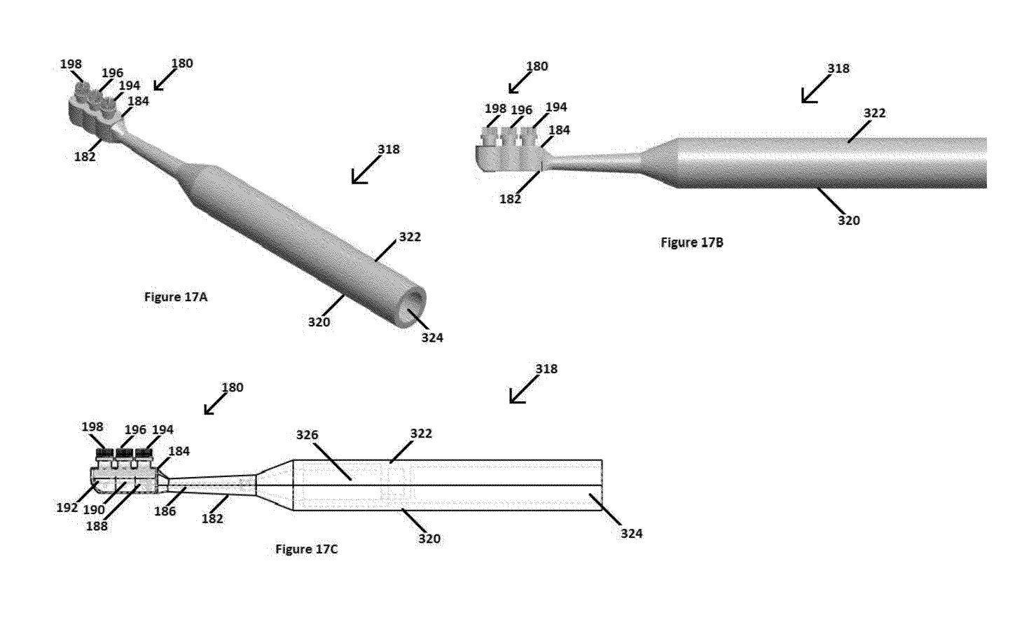

FIGS. 17A through 17C depict an embodiment of a toothbrush (318) that includes the toothbrush head (180) of FIG. 10A. Specifically, FIG. 17A depicts a perspective view of the toothbrush (318), FIG. 17B depicts a side view, and FIG. 17C depicts a side, cross-sectional view thereof. As described previously, the toothbrush head (180) is shown having lower and upper body portions (182, 184) that form a housing that accommodates a shaft (186) and three gears (188, 190, 192). Three bristle assemblies (194, 196, 198) are each shown associated with a respective gear (180, 190, 192), such that movement/rotation of a gear causes corresponding movement/rotation of the associated bristle assembly.

The handle portion of the toothbrush (318) is shown having a lower handle portion (320) and an upper handle portion (322) that can be secured together (e.g., via fasteners, adhesives, and/or other means of attachment) to form a unitary handle having a first interior space (324) usable, e.g., to retain batteries or a similar power source, and a second interior space (326) usable, e.g., to retain a motor. A cap (not shown) or similar type of cover can be placed over the end of the handle to enclose the first interior space (324). In use, a power source (not shown), such as one or more replaceable and/or rechargeable batteries in the first interior space (324) can be used to power a motor (not shown) in the second interior space (326). In an embodiment, actuation of a switch (not shown), e.g., positioned on the handle or elsewhere, can be used to activate the motor to cause rotation of the shaft (186) engaged therewith. Rotation of the shaft (186) can impart rotational movement to the first gear (188) along an axis of rotation perpendicular to that of the shaft (186), rotation of the first gear (188) can impart rotational movement to the second gear (190) in a rotational direction opposite that of the first gear (188), and rotation of the second gear (190) can impart rotational movement of the third gear (192) in a rotational direction opposite that of the second gear (190). Rotation of the gears (188, 190, 192) can in turn cause rotation of the bristle assemblies (194, 196, 198) secured thereto, such that each bristle assembly rotates in a direction opposite that of each adjacent bristle assembly. As described above, the bristle assemblies (194, 196, 198) can be removable and/or replaceable and/or interchangeable, such as with a floss element or other type of rotatable component. While FIGS. 17A through 17C depict a toothbrush (318) able to accommodate batteries and/or similar power sources, it should be understood that in various embodiments, the toothbrush (318) could be operable via any manner of external or internal alternating or direct current source and can include suitable connectors for interfacing with such power sources.

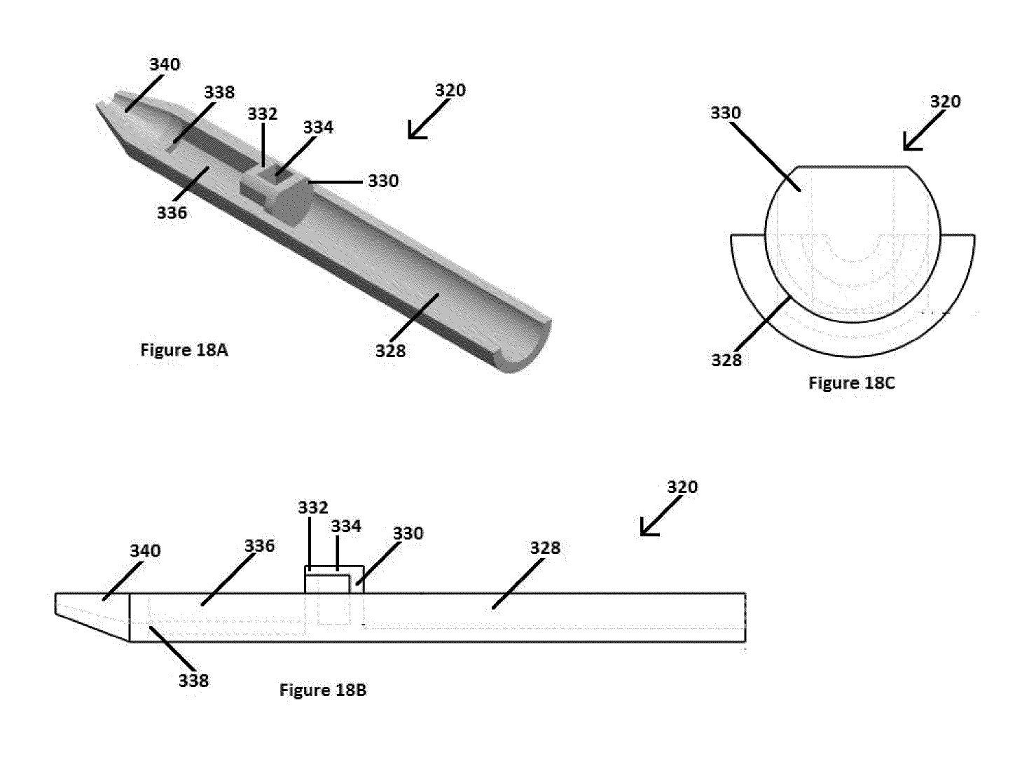

FIGS. 18A through 18C depict the lower handle portion (320) of the toothbrush (318) shown in FIG. 17A. Specifically, FIG. 18A depicts a perspective view of the lower handle portion (320), FIG. 18B depicts a side, cross-sectional view, and FIG. 18C depicts a rear view thereof. The lower handle portion (320) is shown having a generally semi-circular cross-section (e.g., the shape of half of a cylinder), defining a first interior space (328) and a second interior space (336), separated by a dividing wall (330). When assembled with the upper handle portion (322, shown in FIG. 17A), the first and second interior spaces (328, 326) adjoin corresponding spaces in the upper handle portion (322, shown in FIG. 17A) to form the interior spaces (324, 326, shown in FIG. 17C) for accommodating power sources and/or motors, as described above. The dividing wall (330) can include suitable electrical contacts (not shown) for conducting power from batteries and/or other power sources that can be placed in the first interior space (328), while a frame (332) with an upper orifice (334) therein, in combination with the second interior space (336) can be used to accommodate a motor (not shown). In an embodiment, switch (not shown) or similar feature can be accessible, e.g., to actuate the motor, through the orifice (334). The front end of the lower handle portion (320) is shown having a generally conical shape, with a conical interior space (340), separated from the second interior space (336) via an internal shoulder (338). The conical interior space (340) can include a portion of a motor (e.g., extending from the second interior space (336)) and/or a portion of the shaft (186, shown in FIG. 17C) engaged with the motor. When assembled, the conical interior space (340) can adjoin a corresponding space within the upper handle portion (322, shown in FIG. 17C).

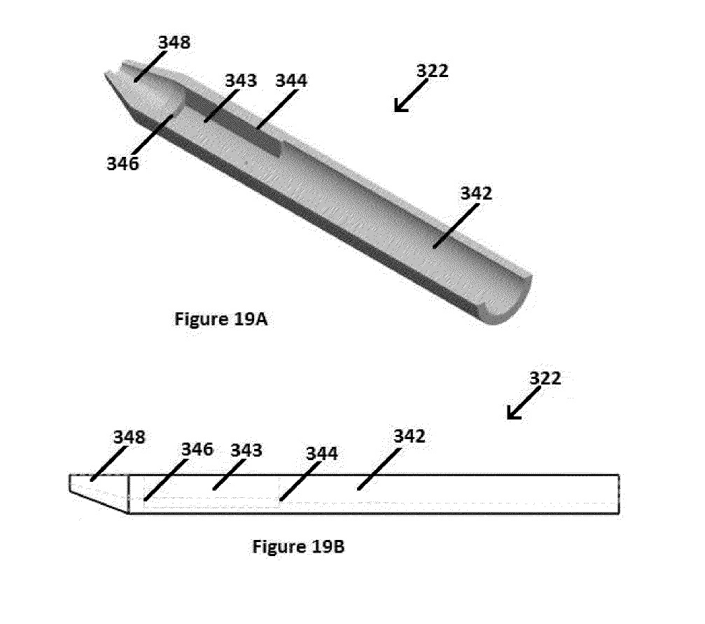

FIGS. 19A and 19B depict the upper handle portion (322) of the toothbrush (318) shown in FIG. 17A. Specifically, FIG. 19A depicts a perspective view of the upper handle portion (322), while FIG. 19B depicts a side, cross-sectional view thereof. The upper handle portion (322) is shown having a body with a generally semi-circular cross section (e.g., having the shape of one-half of a cylinder), and a generally conical end, thereby defining a first internal space (342), contiguous with but conceptually separated from a second internal space (343) via a first internal shoulder (344), and a third internal space (348) within the conical end, separated from the second internal space (343) via a second internal shoulder (346). When assembled with the lower handle portion (320, shown in FIG. 17A), the internal spaces (342, 343, 348) adjoin corresponding internal spaces in the lower handle portion (320, shown in FIG. 17A) to form the internal spaces (324, 326) shown in FIG. 17C.

While various embodiments usable within the scope of the present disclosure have been described with emphasis, it should be understood that within the scope of the appended claims, the present invention can be practiced other than as specifically described herein.

What is claimed is:

1. A toothbrush comprising:
an outer housing having a first orifice, a second orifice, and a third orifice formed therein;
a neck portion having an axial bore therein; and
a head portion comprising:
a first landing adjacent to the neck portion and aligned with the first orifice;
a second landing adjacent to the first landing and aligned with the second orifice;
a third landing adjacent to the second landing and aligned with the third orifice;
a first gear engaged with the first landing and comprising a first portion extending through the first orifice;
a second gear engaged with the second landing and with the first gear, wherein the second gear comprises a second portion extending through the second orifice; and
a third gear engaged with the third landing and the second gear, wherein the third gear comprises a third portion extending through the third orifice;
a first rotatable element engaged with the first portion of the first gear;
a second rotatable element engaged with the second portion of the second gear;
a third rotatable element engaged with the third portion of the third gear; and
a shaft within the axial bore and engaged with the first gear, wherein rotation of the shaft about an axis of the axial bore imparts rotational movement to the first gear about a gear axis perpendicular to the axis of the axial bore thereby rotating the first rotatable element in a first rotational direction, wherein rotation of the first gear imparts rotational movement to the second gear thereby rotating the second rotatable element in a second rotational direction opposite the first rotational direction, and wherein rotation of the second gear imparts rotational movement to the third gear thereby rotating the third rotatable element in the first rotational direction.

2. The toothbrush of claim 1, wherein the outer housing comprises an upper body portion having the first orifice, the second orifice, and the third orifice formed therein, and a lower body portion having the first landing, the second landing, and the third landing formed therein.

3. The toothbrush of claim 1, wherein the first landing comprises a first receptacle formed therein, and wherein the first gear comprises a first insertion region positioned in the first receptacle in a manner that permits rotation of the first gear relative to the first landing, wherein the second landing comprises a second receptacle formed therein, and wherein the second gear comprises a second insertion region positioned in the second receptacle in a manner that permits rotation of the second gear relative to the second landing, and wherein the third landing comprises a third receptacle formed therein, and wherein the third gear comprises a third insertion region positioned in the third receptacle in a manner that permits rotation of the third gear relative to the third landing.

4. The toothbrush of claim 1, wherein the head portion comprises a first sidewall opposite a second sidewall, and wherein the first sidewall and the second sidewall each comprise a first arcuate region adjacent to the first landing, a second arcuate region adjacent to the second landing, and a third arcuate region adjacent to the third landing, wherein the first arcuate regions provide the first landing with a first diameter adapted to enclose the first gear in a manner that permits rotation thereof relative to the first arcuate regions, wherein the second arcuate regions provide the second landing with a second diameter adapted to enclose the second gear in a manner that permits rotation thereof relative to the second arcuate regions, and wherein the third arcuate regions provide the third landing with a third diameter adapted to enclose the third gear in a manner that permits rotation thereof relative to the third arcuate regions.

5. The toothbrush of claim 1, wherein the first gear comprises a first lower portion associated with the first landing, a vertical gear engaged with the shaft, a first horizontal gear engaged with the second gear, and a first top portion extending through the first orifice and engaged with the first rotatable component; wherein the second gear comprises a second lower portion associated with the second landing, a second horizontal gear engaged with the first gear and with the third gear, and a second top portion extending through the second orifice and engaged with the second rotatable component; and wherein the third gear comprises a third lower portion associated with the third landing, a third horizontal gear engaged with the second gear, and a third top portion extending through the third orifice and engaged with the third rotatable component.

6. The toothbrush of claim 5, wherein the vertical gear comprises a first angled surface and wherein the shaft comprises a second angled gear surface parallel to the first angled surface.

7. The toothbrush of claim 5, wherein the first landing comprises a first height, and wherein the second landing, the third landing, or combinations thereof comprises a second height greater than the first height.

8. The toothbrush of claim 7, wherein:
the first gear comprises a first spacing region positioned between the first lower portion and the first horizontal gear,
the second gear comprises a second spacing region positioned between the second lower portion and the second horizontal gear,
the third gear comprises a third spacing region positioned between the third lower portion and the third horizontal gear,
or combinations thereof.

9. The toothbrush of claim 8, wherein the first spacing region, the second spacing region, the third spacing region, or combinations thereof comprises a diameter greater than that of the first orifice, the second orifice, the third orifice, or combinations thereof.

10. The toothbrush of claim 5, wherein the first rotatable component, the second rotatable component, the third rotatable component, or combinations thereof, comprises a bristle assembly having a base section with an orifice therein removably engaged with the first top portion, the second top portion, the third top portion, or combinations thereof, and an upper section having a plurality bristle members extending therefrom, such that rotation of the first gear, the second gear, the third gear, or combinations thereof rotates the bristle assembly.

11. The toothbrush of claim 5, wherein the first rotatable component, the second rotatable component, the third rotatable component, or combinations thereof, comprises a floss assembly having a plurality of floss members with a flexibility greater along a first axis than that along a second axis thereof.

12. The toothbrush of claim 11, wherein the plurality of floss members define an upper surface having a first arcuate region, a second arcuate region, and a generally flat region between the first arcuate region and the second arcuate region.

13. The toothbrush of claim 1, further comprising a handle associated with the neck portion, wherein the handle comprises an upper handle portion and a lower handle portion defining a space therebetween, and wherein the lower body portion comprises a dividing wall extending therefrom and dividing the space into a first chamber rand a second chamber, and wherein a frame having an orifice therein extends from the dividing wall.

14. A toothbrush comprising:
an outer housing comprising a neck portion and a head portion;
a shaft in the neck portion, wherein the shaft comprises a longitudinal axis, a gear on a first end thereof, and a feature on a second end thereof adapted for engagement with an actuator to impart rotational movement to the shaft about the longitudinal axis;
a first gear in the head portion, wherein the first gear comprises a gear axis perpendicular to the longitudinal axis, a first end engaged with the outer housing, a second end extending through a first orifice in the outer housing, a first set of teeth, and a second set of teeth engaged with the gear of the shaft such that rotational movement of the shaft imparts rotational movement to the first gear in a first rotational direction about the gear axis;
a second gear in the head portion, wherein the second gear comprises a first end engaged with the outer housing, a second end extending through a second orifice in the outer housing, and a set of teeth engaged with the first set of teeth of the first gear, such that rotational movement of the first gear in the first rotational direction imparts rotational movement to the second gear in a second rotational direction opposite the first rotational direction; and
a third gear in the head portion, wherein the third gear comprises a first end engaged with the outer housing, a second end extending through a third orifice in the outer housing, and a set of teeth engaged with the set of teeth of the second gear, such that rotational movement of the second gear in the second direction imparts rotational movement to the third gear in the first rotational direction.

15. The toothbrush of claim 14, wherein the head portion comprises:
a first set of opposed arcuate sidewalls positioned adjacent to the first gear to define a first region having a radius corresponding to that of the first gear while permitting rotation of the first gear relative to the outer housing;
a second set of opposed arcuate sidewalls positioned adjacent to the second gear to define a second region having a radius corresponding to that of the second gear while permitting rotation of the second gear relative to the outer housing; and
a third set of opposed arcuate sidewalls positioned adjacent to the third gear to define a third region having a radius corresponding to that of the third gear while permitting rotation of the third gear relative to the outer housing.

16. The toothbrush of claim 14, further comprising a first rotatable component engaged with the second end of the first gear, a second rotatable component engaged with the second end of the second gear, and a third rotatable component engaged with the second end of the third gear, wherein the first rotatable component, the second rotatable component, the third rotatable component, or combinations thereof comprises a bristle assembly comprising:
a base section removably engaged with the second end in a manner that limits rotational movement of the bristle assembly relative to the second end;
a generally circular mounting region associated with the base section; and
a plurality of bristles extending from the mounting region and arranged in at least two concentric circles.

17. The toothbrush of claim 16, wherein the plurality of bristles define an unobstructed, generally flat region located at a center of the mounting region.

18. The toothbrush of claim 14, The toothbrush of claim 14, further comprising a first rotatable component engaged with the second end of the first gear, a second rotatable component engaged with the second end of the second gear, and a third rotatable component engaged with the second end of the third gear, wherein the first rotatable component, the second rotatable component, the third rotatable component, or combinations thereof comprises a floss assembly comprising:
a base section removably engaged with the second end in a manner that limits rotational movement of the floss assembly relative to the second end;
a mounting region associated with the base section; and
a plurality of floss members having a longitudinal axis and a flexibility in directions parallel to the longitudinal axis than that in directions non-parallel to the longitudinal axis.

19. The toothbrush of claim 18, wherein the plurality of floss members comprises an angled upper surface having a first side with a height greater than that of a second side, a first arcuate region, a second arcuate region, and a generally flat region between the first arcuate region and the second arcuate region.

20. A toothbrush comprising:
a handle comprising an upper handle portion secured to a lower handle portion to define a space therebetween, wherein a dividing wall extending from at least one of the upper handle portion and the lower handle portion separates the space into a first chamber and a second chamber, and wherein the first chamber and the second chamber are adapted for containing a motor, at least one power source, or combinations thereof;
a housing comprising a neck region engaged with an end of the handle and a head region adjacent to the neck region, wherein the housing comprises a lower housing portion secured to an upper housing portion to define a first gear space, a second gear space, and a third gear space in the head region and an axial bore in the neck region, wherein the upper housing portion includes a first orifice aligned with the first gear space, a second orifice aligned with the second gear space, and a third orifice aligned with the third gear space, and wherein the lower housing portion includes a first landing having a first height in the first gear space, a second landing having a second height greater than the first height in the second gear space, and a third landing having a third height greater than the first height in the third gear space;
a shaft in the axial bore of the neck region, wherein the shaft comprises a first end proximate to the handle and having a feature thereon adapted to engage a motor in the first chamber of the handle, and a second end having a shaft gear thereon;
a first gear in the first gear space, wherein the first gear comprises a lower end associated with the first landing, an upper end extending through the first orifice, a vertical gear engaged with shaft gear, and a first horizontal gear;
a second gear in the second gear space, wherein the second gear comprises a lower end associated with the second landing, an upper end extending through the second orifice, and a second horizontal gear engaged with the first horizontal gear;
a third gear in the third gear space, wherein the third gear comprises a lower end associated with the third landing, an upper end extending through the third orifice, and a third horizontal gear engaged with the second horizontal gear;
a first rotatable component engaged with the upper end of the first gear such that rotation of the first gear rotates the first rotatable component;
a second rotatable component engaged with the upper end of the second gear such that rotation of the second gear rotates the second rotatable component; and
a third rotatable component engaged with the upper end of third first gear such that rotation of the third gear rotates the third rotatable component.
